(19) United States
(12) Patent Application Publication
(10) Pub. No.: US 2025/0127175 A1
(43) Pub. Date: Apr. 24, 2025

(54) ANTIMICROBIAL POLYMER COMPOSITIONS, ANTIMICROBIAL POLYMER ARTICLES, AND METHODS OF MAKING THE SAME

(71) Applicant: CORNING INCORPORATED, CORNING, NY (US)

(72) Inventors: Xiaole Cheng, Painted Post, NY (US); Insik Jeon, Novi, MI (US)

(21) Appl. No.: 18/711,723

(22) PCT Filed: Nov. 21, 2022
(86) PCT No.: PCT/US2022/050524

§ 371 Date: May 20, 2024

Related U.S. Application Data
(60) Provisional application No. 63/398,709, filed on Aug. 17, 2022.
(60) Provisional application No. 63/282,466, filed on Nov. 23, 2021.

(51) Int. Cl. A01N 59/20; A01N 25/10; A01P 1/00

(52) U.S. Cl. CPC A01N 59/20; A01N 25/10; A01P 1/00

(57) ABSTRACT

An antimicrobial polymer composition comprises from about 5 wt % to about 30 wt % of a copper-containing material, from about 5 wt % to about 30 wt % of an ionic liquid, and from 60 wt % to 90 wt % of a thermoplastic polymer. An antimicrobial polymer article comprises from 0.1 wt % to about 30 wt % of a copper-containing material, from about 0.1 wt % to about 20 wt % of an ionic liquid, and from about 50 wt % to about 99.8 wt % of a thermoplastic polymer. Methods of making an antimicrobial polymer can comprise feeding an antimicrobial polymer composition and an another thermoplastic polymer into a forming apparatus. Methods of making an antimicrobial polymer article comprises feeding a mixture comprising copper-containing material from about 0.1 wt % to about 30 wt %, an ionic liquid from about 0.1 wt % to about 20 wt %, and a thermoplastic polymer into a forming apparatus.

### CROSS-REFERENCE TO RELATED APPLICATIONS

This application claims the benefit of priority under 35 U.S.C. § 119 of U.S. Provisional Application Ser. No. 63/282,466 filed on Nov. 23, 2021 and U.S. Provisional Application Ser. No. 63/398,709 filed on Aug. 17, 2022 the contents of which are relied upon and incorporated herein by reference in their entireties.

### FIELD

The disclosure relates to antimicrobial polymer compositions, antimicrobial polymer articles, and methods of making the same, and more particularly, to antimicrobial polymer compositions and antimicrobial polymer articles comprising a copper-containing material and methods of making the same.

### BACKGROUND

Antimicrobial polymer compositions are used in a broad variety of applications that require both strong antimicrobial efficacy and mechanical durability. Coatings or compositions including inorganic materials including copper have been shown to provide strong antibacterial and antiviral protection, including against novel coronavirus COVID-19.

Generally, a relatively high loading of a copper-containing material has been necessary to achieve strong antimicrobial properties. Such high loading may adversely affect the mechanical properties of the coatings, as well as demand a higher cost premium.

Known antimicrobial polymer compositions obtained by extrusion compounding and followed by injection molding have not demonstrated acceptable antimicrobial efficacy. Though hand sanding, plasma treatment, and embossing have been proposed to overcome the deficient antimicrobial efficacy, such methods are disfavored for mass production due to high cycle time and added cost.

Thus, there is a need to develop antimicrobial polymer compositions that can be extruded and injection molded without any additional steps required to affect the full antimicrobial efficacy of the compositions.

### SUMMARY

There are set forth herein antimicrobial polymer compositions and/or antimicrobial polymer articles comprising a copper-containing material, an ionic liquid, and a thermoplastic polymer, and methods of making the same. The copper-containing material can enable the antimicrobial polymer composition and/or the antimicrobial polymer article to exhibit antimicrobial properties without surface treatment. The ionic liquid can increase an antimicrobial efficacy of the antimicrobial polymer composition, for example, by enabling copper ions to be transported between the copper-containing material and a location containing microbes (e.g., bacteria, viruses, fungi). Providing the ionic liquid can enhance an antimicrobial effect of the antimicrobial polymer composition and/or antimicrobial polymer article, for example, by allowing a relatively low amount of copper-maintaining material (e.g., about 5 wt % or less, about 2 wt % or less, about 0.5 wt %) to release copper ions that can effectively interact with microbial cells at the exterior surface. As demonstrated by the Examples, antimicrobial efficacy comparable to pure copper surfaces can be obtained with 5 wt % or less (e.g., 2 wt % or less) of the copper containing material. Further, the antimicrobial polymer article can satisfy the 3 logarithm reduction in antimicrobial activity to qualify as a sanitizer with about 0.5 wt % or less of the copper-containing material.

The antimicrobial polymer composition can be combined with another thermoplastic polymer using common polymer forming techniques to produce an antimicrobial polymer article. Providing the antimicrobial polymer composition as a masterbatch can simplify processing to produce an antimicrobial polymer article, where the masterbatch can be mixed with another thermoplastic without concern for dispersion and/or incorporation of components in the masterbatch since these components are already incorporated and dispersed in the masterbatch. Providing the antimicrobial polymer composition can enable mixing with about 5 times or more of the another thermoplastic polymer while maintaining antimicrobial efficacy. Providing a common functional group in both the thermoplastic polymer and the another thermoplastic polymer can increase a compatibility of the thermoplastic polymers in the resulting antimicrobial polymer article, which can reduce processing costs, increase homogeneity of the resulting antimicrobial polymer article, and/or improve the antimicrobial effectiveness of the resulting antimicrobial polymer article. Providing the antimicrobial polymer composition as a powder, a flake, a chip, or a pellet can improve a homogeneity of the resulting antimicrobial polymer composition and/or reduce processing resources (e.g., time, energy) to fully soften the thermoplastic material. Additionally, the antimicrobial polymer compositions of the examples of the present disclosure are easily processable, have high flow, and do not mechanically deteriorate. The use of an ionic liquid in antimicrobial polymer compositions of the examples of the present disclosure also increase the environmental friendliness of the antimicrobial polymer compositions.

The disclosure provides for the following aspects, the numbering of which is not to be construed as designating levels of importance:

Aspect 1. An antimicrobial polymer composition, comprising, based on a total 100 wt % of the antimicrobial polymer composition:
from about 5 wt % to about 30 wt % of a copper-containing material;
from about 5 wt % to about 30 wt % of an ionic liquid, the ionic liquid is water-soluble; and
from about 60 wt % to about 90 wt % of a thermoplastic polymer.

Aspect 2. The antimicrobial polymer composition of aspect 1, wherein the copper-containing material comprises cuprous oxide or a copper-containing glass-ceramic particle.

Aspect 3. The antimicrobial polymer composition of any one of aspects 1-2, wherein the ionic liquid comprises a cation selected from a group consisting of formulae (I), (II), (III), (IV), (V), (VI), (VII), or (VIII):

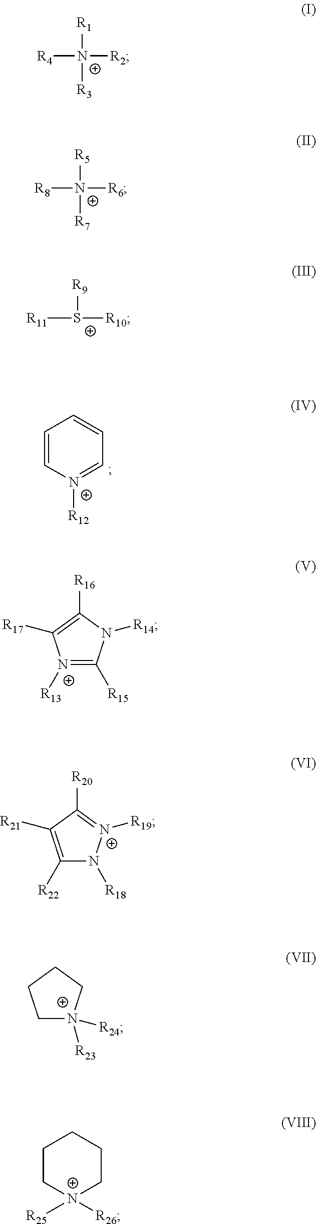

wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, R₂₄, R₂₅, and R₂₆ are each independently selected from a group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₁, R₂, R₃, and R₄, and/or any two of R₅, R₆, R₇, and R₈, and/or any two of R₉, R₁₀, and R₁₁, and/or any two adjacent substituent groups of R₁₃, R₁₄, R₁₅, R₁₆, and R₁₇, and/or any two adjacent substituent groups of R₁₈, R₁₉, R₂₀, R₂₁, and R₂₂, and/or R₂₃ and R₂₄ together, and/or R₂₅ and R₂₆ together, in either direction, are selected from a group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene;
provided that all of R₁, R₂, R₃, and R₄ are not simultaneously hydrogen;
provided that all of R₅, R₆, R₇, and R₈ are not simultaneously hydrogen;
provided that all of R₉, R₁₀, and R₁₁ are not simultaneously hydrogen;
provided that R₁₃ and R₁₄ are not simultaneously hydrogen;
provided that R₁₈ and R₁₉ are not simultaneously hydrogen;
provided that R₂₃ and R₂₄ are not simultaneously hydrogen; and provided that R₂₅ and R₂₆ are not simultaneously hydrogen.

Aspect 4. The antimicrobial polymer composition of aspect 3, wherein the cation of the ionic liquid is an alkyl imidazolium.

Aspect 5. The antimicrobial polymer composition of any one of aspects 1-4, wherein the ionic liquid comprises an anion selected from a group consisting of hexafluorophosphate, bistriflimide, tetrafluoroborate, triflate, dicyanamide, acetate, trifluoroacetate, nitrate, bromide, chloride, iodide, heptachlorodialuminate, tetrachlorodialuminate, and a species of formula (IX):

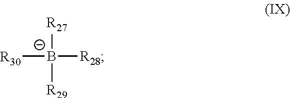

wherein R₂₇, R₂₈, R₂₉, and R₃₀ are each independently selected from a group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₂₇, R₂₈, R₂₉, and R₃₀ taken together, in either direction, are selected from a group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene; and
provided that all of R₂₇, R₂₈, R₂₉, and R₃₀ are not simultaneously hydrogen.

Aspect 6. The antimicrobial polymer composition of any one of aspects 1-5, wherein the antimicrobial polymer composition comprises a powder, a chip, a flake, or a pellet.

Aspect 7. The antimicrobial polymer composition of any one of aspects 1-6, wherein the thermoplastic polymer comprises a thermoplastic polyurethane or a polyamide.

Aspect 8. A method of making an antimicrobial polymer article comprising:
feeding an antimicrobial polymer composition and an another thermoplastic polymer into a forming apparatus;
softening the antimicrobial polymer composition and the another thermoplastic polymer together in the forming apparatus to form a mixed composition; and
forming the mixed composition into a predetermined shape,
wherein the antimicrobial polymer composition comprises, based on a total 100 wt % of the antimicrobial polymer composition:
   from about 5 wt % to about 30 wt % of a copper-containing material;
   from about 5 wt % to about 30 wt % of an ionic liquid, the ionic liquid is water-soluble; and
   from about 60 wt % to about 90 wt % of a thermoplastic polymer.

Aspect 9. The method of aspect 8, wherein the mixed composition of the antimicrobial polymer article comprises, based on a total 100 wt % of the mixed composition:
from about 0.5 wt % to about 5 wt % of the copper-containing material; and
from about 0.5 wt % to about 5 wt % of the ionic liquid.

Aspect 10. The method of any one of aspects 8-9, wherein a weight ratio of the another thermoplastic polymer to the antimicrobial polymer composition is from about 5 to about 30.

Aspect 11. The method of any one of aspects 8-10, wherein the copper-containing material comprises cuprous oxide or a copper-containing glass-ceramic particle.

Aspect 12. The method of any one of aspects 8-11, wherein the thermoplastic polymer comprises a first functional group, and the another thermoplastic polymer comprises the first functional group.

Aspect 13. The method of any one of aspects 8-12, wherein a composition of the thermoplastic polymer is the same as a composition of the another thermoplastic polymer.

Aspect 14. The method of any one of aspects 8-13, wherein the ionic liquid comprises a cation selected from a group consisting of formulae (I), (II), (III), (IV), (V), (VI), (VII), or (VIII):

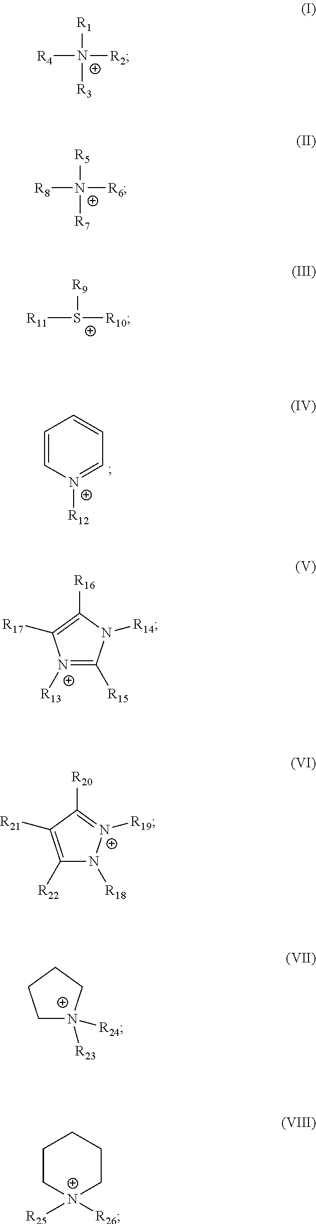

wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, R₂₄, R₂₅, and R₂₆ are each independently selected from a group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₁, R₂, R₃, and R₄, and/or any two of R₅, R₆, R₇, and R₈, and/or any two of R₉, R₁₀, and R₁₁, and/or any two adjacent substituent groups of R₁₃, R₁₄, R₁₅, R₁₆, and R₁₇, and/or any two adjacent substituent groups of R₁₈, R₁₉, R₂₀, R₂₁, and R₂₂, and/or R₂₃ and R₂₄ together, and/or R₂₅ and R₂₆ together, in either direction, are selected from a group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene;
provided that all of R₁, R₂, R₃, and R₄ are not simultaneously hydrogen;
provided that all of R₅, R₆, R₇, and R₈ are not simultaneously hydrogen;
provided that all of R₉, R₁₀, and R₁₁ are not simultaneously hydrogen;
provided that R₁₃ and R₁₄ are not simultaneously hydrogen;
provided that R₁₈ and R₁₉ are not simultaneously hydrogen;
provided that R₂₃ and R₂₄ are not simultaneously hydrogen; and
provided that R₂₅ and R₂₆ are not simultaneously hydrogen.

Aspect 15. The method of aspect 14, wherein the cation of the ionic liquid is an alkyl imidazolium.

Aspect 16. The method of any one of aspects 8-15, wherein the ionic liquid comprises an anion selected from a group consisting of hexafluorophosphate, bistriflimide, tetrafluoroborate, triflate, dicyanamide, acetate, trifluoroacetate, nitrate, bromide, chloride, iodide, heptachlorodialuminate, tetrachlorodialuminate, and a species of formula (IX):

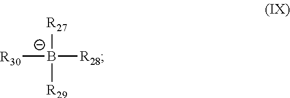

wherein R₂₇, R₂₈, R₂₉, and R₃₀ are each independently selected from a group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl; optionally wherein any two of R₂₇, R₂₈, R₂₉, and R₃₀ taken together, in either direction, are selected from a group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene; and
provided that all of R₂₇, R₂₈, R₂₉, and R₃₀ are not simultaneously hydrogen.

Aspect 17. The method of any one of aspects 8-16, wherein the antimicrobial polymer article comprises a logarithmic reduction of at least 3 for at least one of Staphylococcus aureus, Enterobacter aerogenes, Pseudomonas aeruginosa bacteria, Methicillin-Resistant Staphylococcus aureus, or E. coli.

Aspect 18. The method of any one of aspects 8-17, wherein the antimicrobial polymer article further comprises an additive selected from a group consisting of an impact modifier, a flame retardant, an ultraviolet inhibitor, an antistatic agent, a mold release agent, a filler, a colorant, and combinations thereof.

Aspect 19. The method of any one of aspects 8-18, wherein the forming apparatus comprises an extruder or an injection molding apparatus, and forming the mixed composition into the predetermined shape comprises extruding or injection molding the mixed composition.

Aspect 20. The method of any one of aspects 8-19, further comprising, before the feeding the antimicrobial polymer composition and the another thermoplastic polymer:
mixing the copper-containing material, the ionic liquid, and the thermoplastic polymer in an extruder to form a mixture; and
extruding the mixture to form the antimicrobial polymer composition.

Aspect 21. The method of any one of aspects 8-20, wherein the thermoplastic polymer comprises a thermoplastic polyurethane or a polyamide, and the another thermoplastic polymer comprises a thermoplastic polyurethane or a polyamide.

Aspect 22. An antimicrobial polymer article comprising, based on a total 100 wt % of the antimicrobial polymer article:
from about 0.1 wt % to about 30 wt % of a copper-containing material;
from about 0.1 wt % to about 20 wt % of an ionic liquid, the ionic liquid is water-soluble; and
from about 50 wt % to about 99.8 wt % of a thermoplastic polymer.

Aspect 23. The antimicrobial polymer article of aspect 22, wherein the antimicrobial polymer article comprises:
from about 0.1 wt % to about 5 wt % of the copper-containing material; and
from about 0.1 wt % to about 5 wt % of the ionic liquid.

Aspect 24. The antimicrobial polymer article of one of aspects 22-23, wherein the copper-containing material comprises cuprous oxide or a copper-containing glass-ceramic particle.

Aspect 25. The antimicrobial polymer article of any one of aspects 22-24, wherein the ionic liquid comprises a cation selected from a group consisting of formulae (I), (II), (III), (IV), (V), (VI), (VII), or (VIII):

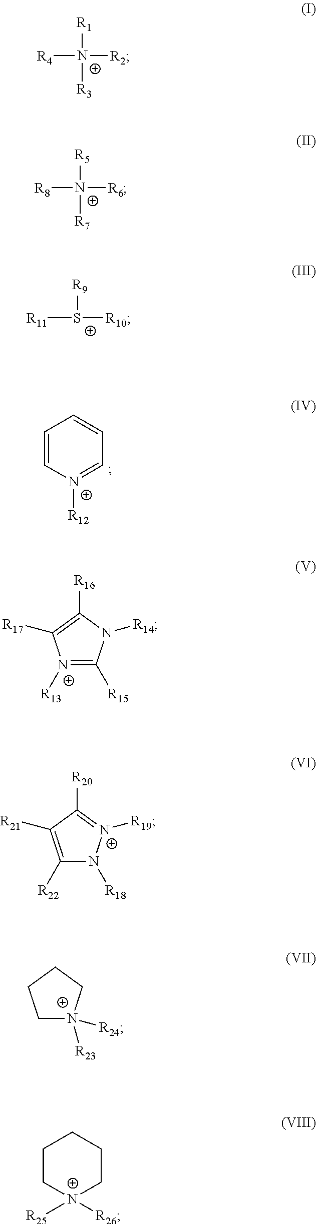

wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, R₂₄, R₂₅, and R₂₆ are each independently selected from a group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₁, R₂, R₃, and R₄, and/or any two of R₅, R₆, R₇, and R₈, and/or any two of R₉, R₁₀, and R₁₁, and/or any two adjacent substituent groups of R₁₃, R₁₄, R₁₅, R₁₆, and R₁₇, and/or any two adjacent substituent groups of R₁₈, R₁₉, R₂₀, R₂₁, and R₂₂, and/or R₂₃ and R₂₄ together, and/or R₂₅ and R₂₆ together, in either direction, are selected from a group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene;
provided that all of R₁, R₂, R₃, and R₄ are not simultaneously hydrogen;
provided that all of R₅, R₆, R₇, and R₈ are not simultaneously hydrogen;
provided that all of R₉, R₁₀, and R₁₁ are not simultaneously hydrogen;
provided that R₁₃ and R₁₄ are not simultaneously hydrogen;
provided that R₁₈ and R₁₉ are not simultaneously hydrogen;
provided that R₂₃ and R₂₄ are not simultaneously hydrogen; and
provided that R₂₅ and R₂₆ are not simultaneously hydrogen.

Aspect 26. The antimicrobial polymer article of aspect 25, wherein the cation of the ionic liquid is an alkyl imidazolium.

Aspect 27. The antimicrobial polymer article of any one of aspects 22-26, wherein the ionic liquid comprises an anion selected from a group consisting of hexafluorophosphate, bistriflimide, tetrafluoroborate, triflate, dicyanamide, acetate, trifluoroacetate, nitrate, bromide, chloride, iodide, heptachlorodialuminate, tetrachlorodialuminate, and a species of formula (IX):

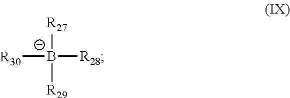

wherein R₂₇, R₂₈, R₂₉, and R₃₀ are each independently selected from a group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₂₇, R₂₈, R₂₉, and R₃₀ taken together, in either direction, are selected from a group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene; and
provided that all of R₂₇, R₂₈, R₂₉, and R₃₀ are not simultaneously hydrogen.

Aspect 28. The antimicrobial polymer article of any one of aspects 22-27, wherein the antimicrobial polymer article is configured to have a logarithmic reduction of at least 3 for at least one of Staphylococcus aureus, Enterobacter aerogenes, Pseudomonas aeruginosa bacteria, Methicillin-Resistant Staphylococcus aureus, or E. coli.

Aspect 29. The antimicrobial polymer article of any one of aspects 22-28, further comprising an additive selected from the group consisting of an impact modifier, a flame retardant, an ultraviolet inhibitor, an antistatic agent, a mold release agent, a filler, and a colorant.

Aspect 30. The antimicrobial polymer article of any one of aspects 22-29, wherein the thermoplastic polymer comprises a thermoplastic polyurethane or a polyamide.

Aspect 31. A method of making an antimicrobial polymer article, comprising:
feeding a mixture comprising copper-containing material in an amount from about 0.1 wt % to about 30 wt %, an ionic liquid in an amount from about 0.1 wt % to about 20 wt %, and a thermoplastic polymer, based on a total 100 wt % of the mixture, into an extruder, wherein the ionic liquid and the copper-containing material are blended together prior to the feeding;
mixing the mixture comprising the copper-containing material, the ionic liquid, and the thermoplastic polymer in the extruder;
softening the thermoplastic polymer; and
extruding the mixture into a predetermined shape,
wherein the ionic liquid is water-soluble.

Aspect 32. The method of aspect 31, further comprising injection molding, thermal forming, compression molding, transfer molding, casting, blow molding, calendering, or laminating the mixture comprising the predetermined shape into the antimicrobial polymer article.

Aspect 33. The method of any one of aspects 31-32, wherein the copper-containing material comprises cuprous oxide and/or glass-ceramic particles.

Aspect 34. The method of any one of aspects 31-33, wherein the ionic liquid comprises a cation selected from a group consisting of formulae (I), (II), (III), (IV), (V), (VI), (VII), or (VIII):

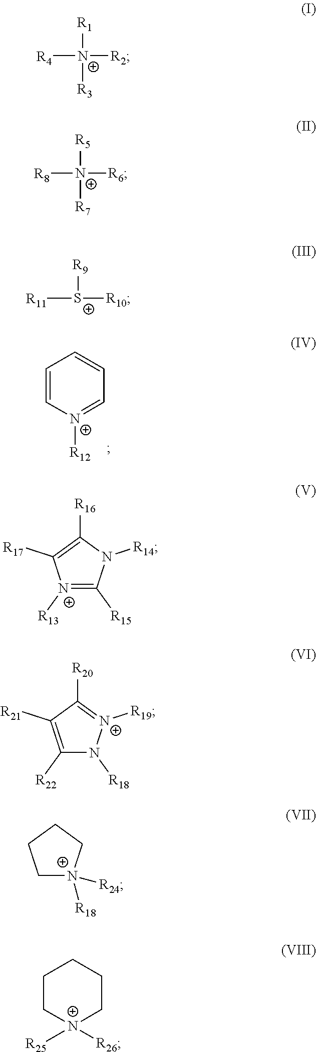

wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, R₂₄, R₂₅, and R₂₆ are each independently selected from the group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₁, R₂, R₃, and R₄, and/or any two of R₅, R₆, R₇, and R₈, and/or any two of R₉, R₁₀, and R₁₁, and/or any two adjacent substituent groups of R₁₃, R₁₄, R₁₅, R₁₆, and R₁₇, and/or any two adjacent substituent groups of R₁₈, R₁₉, R₂₀, R₂₁, and R₂₂, and/or R₂₃ and R₂₄ together, and/or R₂₅ and R₂₆ together, in either direction, are selected from the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene; provided that all of R₁, R₂, R₃, and R₄ are not simultaneously hydrogen;
provided that all of R₅, R₆, R₇, and R₈ are not simultaneously hydrogen;
provided that all of R₉, R₁₀, and R₁₁ are not simultaneously hydrogen;
provided that R₁₃ and R₁₄ are not simultaneously hydrogen;
provided that R₁₈ and R₁₉ are not simultaneously hydrogen;
provided that R₂₃ and R₂₄ are not simultaneously hydrogen; and
provided that R₂₅ and R₂₆ are not simultaneously hydrogen.

Aspect 35. The method of any one of aspects 31-34, wherein the ionic liquid comprises an anion selected from a group consisting of hexafluorophosphate, bistriflimide, tetrafluoroborate, triflate, dicyanamide, acetate, trifluoroacetate, nitrate, bromide, chloride, iodide, heptachlorodialuminate, tetrachlorodialuminate, and a species of formula (IX):

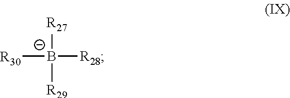

wherein R₂₇, R₂₈, R₂₉, and R₃₀ are each independently selected from the group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, and heterocyclyl(C₁-C₄)alkyl;
optionally wherein any two of R₂₇, R₂₈, R₂₉, and R₃₀ taken together, in either direction, are selected from the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene; and
provided that all of R₂₇, R₂₈, R₂₉, and R₃₀ are not simultaneously hydrogen.

Aspect 36. The method of any one of aspects 31-35, wherein the thermoplastic polymer is selected from a group consisting of a polyamide, a thermoplastic polyurethane, a polyolefin, a polyacrylate, a polyurea, a polyimide, polystyrene, polycarbonate, polyvinyl chloride, acrylonitrile butadiene styrene, a fluoropolymer, a polyester, a silicone resin, a terpolymer, and any combination or blend or copolymer thereof.

Aspect 37. The method of any one of aspects 31-36, wherein the antimicrobial polymer article comprises a logarithmic reduction of at least 3 for at least one of Staphylococcus aureus, Enterobacter aerogenes, Pseudomonas aeruginosa bacteria, Methicillin-Resistant Staphylococcus aureus, or E. coli.

Aspect 38. The method of any one of aspects 31-37, wherein the antimicrobial polymer article further comprises an additive selected from the group consisting of an impact modifier, a flame retardant, an ultraviolet inhibitor, an antistatic agent, a mold release agent, a filler, and a colorant.

Aspect 39. The method of any one of aspects 38, wherein the thermoplastic polymer comprises a thermoplastic polyurethane or a polyamide.

### DESCRIPTION OF THE DRAWINGS

The above and other features and advantages of aspects of the present disclosure are better understood when the following detailed description is read with reference to the accompanying drawings, in which:

FIG. 1 schematically illustrates an antimicrobial polymeric article in accordance with aspects of the disclosure;

FIG. 2 is a flow chart illustrating example methods of making antimicrobial polymer compositions and/or antimicrobial polymer articles in accordance with aspects of the disclosure;

FIG. 3 schematically illustrates steps in methods of making a antimicrobial polymer composition and/or antimicrobial polymer article in accordance with aspects of the disclosure;

FIG. 4 illustrates a bar graph plot of antimicrobial logarithmic reduction for compositions according to Table 3, including polyamide 6, TPU, PBT, or PS as thermoplastic, with and without adding 1-butyl-3-methylimidazolium bromide (BMBr) or 1-butyl-3-methylimidazolium hexafluorophosphate (BMPF₆), and with and without 5 wt % copper-containing material, wherein the copper-containing material is copper-containing glass-ceramic particles; and

FIG. 5 illustrates a bar graph plot of antimicrobial logarithmic reduction for compositions of Examples 2 and 7-12, including thermoplastic polyurethane (TPU), and various concentrations of (1-butyl-3-methylimidazolium bromide (BMBr)) and copper-containing material, wherein the copper-containing material is copper-containing glass-ceramic particles.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

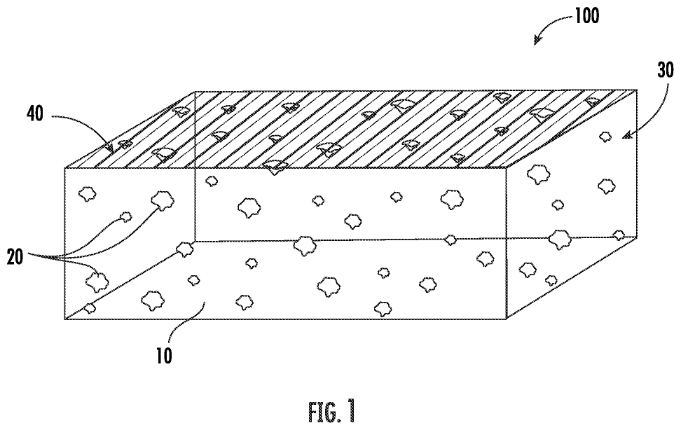

The disclosure relates, generally, to antimicrobial polymer compositions, antimicrobial polymer articles, and methods of making the same. FIG. 1 schematically illustrates an antimicrobial polymeric article in accordance with aspects of the disclosure. Unless otherwise noted, a discussion of features of aspects can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As used herein, the term “antimicrobial” means a material or surface that kills or inhibits the growth of microbes including bacteria, viruses, mildew, mold, algae, and/or fungi. The term antimicrobial does not require the material or surface to kill or inhibit the growth of all of such families of microbes or all species of microbes within such families, but that the material or surface kills or inhibits the growth of one or more species of microbes from one or more of such families.

As used herein, the term “logarithmic reduction” means the negative value of log(Cₐ/C₀), where Cₐ is the colony form unit (CFU) member of the antimicrobial surface and C₀ is the CFU number of the control surface that is not an antimicrobial surface. As an example, a 3 logarithmic reduction equals about 99.9% of the microbes killed and a 5 logarithmic reduction equals about 99.999% of microbes killed. The logarithmic reduction can be measured according to the procedures outlined in the U.S. Environmental Protection Agency Office of Pesticide Programs Protocol for the Evaluation of Bactericidal Activity of Hard, Non-porous Copper Containing Surface Products, dated 29 Jan. 2016. As used herein, the “EPA Test” refers to the method for evaluating the logarithmic reduction of a material described herein under one or more of the U.S. Environmental Protection Agency “Test Method of Efficacy of Copper Alloy as a Sanitizer” (2009) (also referred to herein as the “EPA Test”). For bacteria, the logarithmic reduction can be evaluated using the EPA Test or the Modified Japanese Industrial Standard (JIS) Z 2801 Test for Bacterial and/or the Modified JIS Z 2801 Test for Viruses, for example, measured for a period of one month or more, for a period of three months or more, for a period of six months or more, or for a period of one year or more, wherein the corresponding period may commence at or after the antimicrobial polymer composition or antimicrobial polymer article is manufactured. For viruses, the logarithmic reduction can be evaluated using the Modified JIS Z 2801 (2000) Test for Viruses described in International Patent Application Pub. No. 2021/055300 A1, COLOR STABILIZATION OF BIOCIDAL COATINGS, which is incorporated by reference herein in its entirety.

The effectiveness of a composition of the present disclosure as an antimicrobial composition may be measured as a function of the composition's logarithmic reduction. The composition's logarithmic reduction value may be relevant to its ability to kill a wide variety of biological organisms to which the composition is exposed, but may also allow the copper-containing material to act as a preservative for the composition during use and/or storage in a container (e.g., a tank, a can, a bucket, a drum, a bottle, or a tube). According to Examples herein, a logarithmic reduction of the antimicrobial composition (e.g., antimicrobial polymer composition, antimicrobial polymer article) may be at least about 2, at least about 3, at least about 4, at least about 5, in a range from about 1 to about 6, about 2 to about 5, about 3 to about 5, from about 3 to about 4, or less than, equal to, or greater than about 3, 4, 5, or about 6. The antimicrobial properties of the composition may make it effective for substantially killing a wide variety of biological organisms including bacteria, viruses, and fungi. Where the composition is configured to have antimicrobial efficacy with respect to bacteria, suitable examples of bacteria include Staphylococcus aureus, Enterobacter aerogenes, Pseudomonas aeruginosa, Methicillin-Resistant Staphylococcus aureus, E. coli, Enterobacter cloacae, Acinetobacter baumannii, Enterococcus faecalis, Klebsiella pneumoniae, Klebsiella aerogenes, or mixtures thereof. In aspects, the copper-containing material exhibits at least a 4 logarithmic reduction, a 5 logarithmic reduction, or even a 6 logarithmic reduction in the concentration of at least one of Staphylococcus aureus, Enterobacter aerogenes, Pseudomonas aeruginosa bacteria, Methicillin-Resistant Staphylococcus aureus, and E. coli under the EPA test, or a 4 logarithmic reduction or greater (e.g., 5 logarithmic reduction or greater) under JIS Z 2801 (2000) testing conditions or under the Modified JIS Z 2801 Test for Bacteria. In aspects, the copper-containing particles exhibit a 2 logarithmic reduction or greater, a 3 logarithmic reduction or greater, a 4 logarithmic reduction or greater, or a 5 logarithmic reduction or greater in Murine norovirus under a Modified JIS Z 2801 for Viruses test. Examples of viruses that an antimicrobial polymer composition of the present disclosure may kill may include, but are not limited to, Influenza H1N1, Adenovirus 5, Norovirus, and coronavirus. An example of a fungus that an antimicrobial polymer composition of the present disclosure may kill may include, but is not limited to, Candida auris.

The present disclosure provides an antimicrobial polymer composition comprising a copper-containing material, an ionic liquid, and a thermoplastic polymer. The copper-containing material is configured to provide a plurality of Cu¹⁺ ions. The copper-containing material comprises copper as one or more of Cu⁰, Cu¹⁺, Cu²⁺, or combinations thereof. In aspects, a percentage of all copper in the copper-containing material, 50% or more, about 60% or more, about 70% or more, about 80% or more, about 85% or more, or about 90% or more. The relative amounts of Cu¹⁺, Cu²⁺, and Cu⁰ may be determined using X-ray photoluminescence spectroscopy (XPS). As discussed below, an amount of Cu²⁺ may be reduced such that the copper-containing material is substantially free of Cu²⁺. The copper of the copper-containing material may be non-complexed or may have a ligand bonded thereto to form a complex. The copper-containing material may include copper-containing glass, copper oxide, copper metal, and/or copper salt (e.g., copper halide, copper acetate, copper sulfate, or a combination thereof).

In aspects, the copper-containing material comprises cuprous oxide and/or glass-ceramic particles. As used herein, “cuprous oxide” means an oxide containing Cu¹⁺ ions, which can be crystalline as cuprite (Cu₂O). In further aspects, the copper-containing material can consist of cuprous oxide. In aspects, the copper-containing material can comprise cuprite crystals, which can have an average major dimension of about 5 micrometers (μm) or less, for example, from about 0.1 μm to about 5 μm, from about 0.2 μm to about 4 μm, from about 0.3 μm to about 3 μm, from about 0.5 to about 2 μm, from about 1 μm to about 1.5 μm, or any range or subrange therebetween. As used herein, “average” in “average major dimension” refers to a mean value; and the “major dimension” is the greatest dimension of a cuprite crystal as measured by SEM.

In aspects, the copper-containing material can comprise a copper-containing glass-ceramic particle. As used herein, “glass-ceramic” material comprises one or more crystalline phases and an amorphous, residual glass phase. In further aspects, a crystalline phase of the glass-ceramic can comprise cuprous oxide, although a crystalline phase can comprise another, non-copper-containing material in other aspects. In further aspects, the Cu¹⁺ ions may be present in a glass network and/or a glass matrix of the copper-containing glass-ceramic particles. Where the Cu¹⁺ ions are present in the glass network, the Cu¹⁺ ions are atomically bonded to atoms in the glass network. Where the Cu¹⁺ ions are present in the glass matrix, the Cu¹⁺ ions may be present in the form of Cu¹⁺ crystals that are dispersed in the glass matrix. In aspects, the Cu¹⁺ crystals include cuprite (Cu₂O). Without being bound by theory, where Cu¹⁺ ions are part of the glass network, it is believed that during typical glass formation processes, the cooling step of the molten glass occurs too rapidly to allow crystallization of the copper-containing oxide (e.g., Cu and/or Cu₂O). Thus, the Cu¹⁺ remains in an amorphous state and becomes part of the glass network. The Cu¹⁺ ions may be present on or in the surface and/or the bulk of the copper-containing glass particles. The copper-containing glass particles may include copper-containing glass, copper (I) oxide, copper (I) halides, copper (I) carbonate, or a combination thereof. In aspects, the copper-containing glass particles may include only one of copper-containing glass, copper (I) oxide, copper (I) halides, or copper (I) carbonate.

The copper-containing glass-ceramic particle can comprise, but is not limited to, in mol % on an oxide basis: SiO₂ from about 30 mol % to about 70 mol %, Al₂O₃ from 0 mol % to about 20 mol %, copper oxide from about 10 mol % to about 50 mol %, CaO from 0 mol % to about 15 mol %, MgO from 0 mol % to about 15 mol %, P₂O₅ from 0 mol % to 25 mol %, B₂O₃ from 0 mol % to about 25 mol %, K₂O from 0 mol % to about 20 mol %, ZnO from 0 mol % to about 5 mol %, Na₂O from 0 mol % to about 20 mol %, Fe₂O₃ from 0 mol % to about 5 mol %, and/or a mixture thereof. Throughout the disclosure, “on an oxide basis” accounts for materials as if they in the stated oxide form whether or not the non-oxide element is part of the stated oxide or not. For example, SiO₂ on an oxide basis refers to all silicon atoms treated as if all silicon atoms were in SiO₂ molecules. The elemental composition (e.g., amount of Si, Al, Ca, Mg, P, B, K, Zn, Na, Fe) of a material (e.g., copper-containing glass-ceramic particle) can be determined using energy dispersive X-ray spectroscopy (EDS). In aspects, an amount of copper, in mol % on an oxide basis, is greater than an amount of Al₂O₃ on a mol % basis. In aspects, the copper-containing glass-ceramic particle can include one or more colorants, for example, TiO₂, Fe₂O₃, Cr₂O₃, Co₃O₄, which may be present from about 0.01 mol % to about 10 mol %, from about 1 mol % to about 8 mol %, from about 2 mol % to about 5 mol %, or any range or subrange therebetween. Examples of copper-containing glasses and/or copper-containing glass-ceramics include, without limitation, those described in U.S. Pat. No. 9,622,483, ANTIMICROBIAL GLASS COMPOSITIONS, GLASSES AND POLYMERIC ARTICLES INCORPORATING THE SAME, and International Patent Application Pub. No. 2017/132179, ANTIMICROBIAL PHASE-SEPARABLE GLASS/POLYMER ARTICLES AND METHODS FOR MAKING THE SAME, each of which is incorporated by reference herein in its entirety.

In aspects, the copper-containing material can comprise a durable phase and a degradable phase. As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates. The durable phase can comprise at least one of B₂O₃, P₂O₅, or R₂O. “R₂O” means alkali metal oxides, including Li₂O, Na₂O, K₂O, Rb₂O, and Cs₂O. The degradable phase can comprise SiO₂ and Cu¹⁺ ions. In further aspects, a wt % of the durable phase can be greater than a wt % of the degradable phase. The degradable phase leaches or is leachable in the presence of water or a water-soluble compound (e.g., ionic liquid). In further aspects, the degradable phase withstands degradation for 1 week or longer, 1 month or longer, 3 months or longer, or even 6 months or longer. Longevity may be characterized as maintaining antimicrobial efficacy over a specific period of time. In further aspects, the durable phase and/or the degradable phase may include cuprite.

In aspects, the copper (e.g., Cu¹⁺ ions or all copper), as a wt % of the copper-containing material, from 5 wt % to about 80 wt %, from about 10 wt % to about 70 wt %, from about 20 wt % to about 60 wt %, from about 25 wt % to about 50 wt %, from about 27 wt % to about 40 wt %, from about 29 wt % to about 36 wt %, or any range or subrange therebetween. In aspects, the copper-containing glass-ceramic can comprise copper, as a mol % of the copper-containing glass-ceramic on an oxide basis, from about 10 mol % to about 50 mol %, from about 15 mol % to about 45 mol %, from about 20 mol % to about 40 mol %, from about 25 mol % to about 38 mol %, from about 29 mol % to about 36 mol %, or any range or subrange therebetween.

In aspects, the copper-containing material can comprise, as a wt % of the antimicrobial polymer composition, from about 5 wt % to about 30 wt %, from about 8 wt % to about 25 wt %, from about 10 wt % to about 20 wt %, from about 12 wt % to about 15 wt %, or any range or subrange therebetween. In further aspects, copper ions can be leached from the copper-containing material when exposed or in contact with a leachate. Leachates may include water, acids, water-soluble ionic liquids, or other similar materials.

The antimicrobial polymer composition comprises anionic liquid. Ionic liquids comprise a salt made up of a cation and an anion, each of which is in the liquid state at room temperature, or that melt into a liquid state at temperatures below 100° C. In aspects, the ionic liquid is water-soluble. As used herein, “water-soluble” refers to the ability of a minimum of 20 grams of a chemical substance to freely dissolve in 100 milliliters of water at 25° C. (e.g., ambient temperature) and form an aqueous solution of the chemical substance. Providing an ionic liquid can increase an antimicrobial efficacy of the antimicrobial polymer composition, for example, by copper ions to be transported between the copper-containing material and a location containing microbes (e.g., bacteria, viruses, fungi).

In aspects, the ionic liquid may include a cation comprising any of formulae (I)—(VIII):

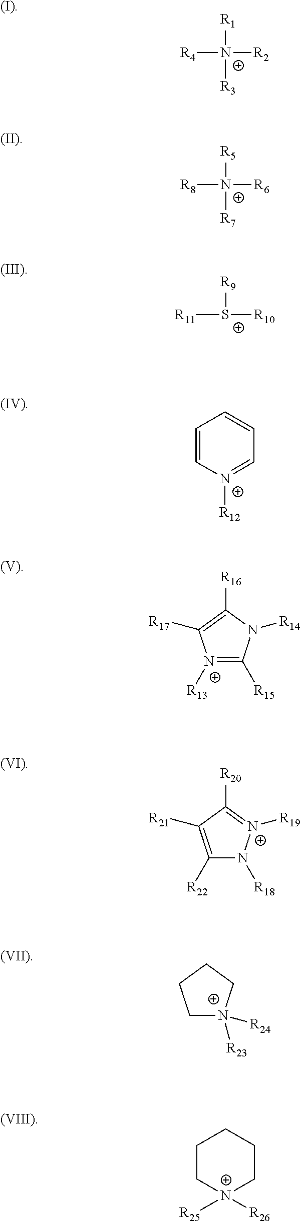

In aspects, the ionic liquid may include a mixture of two or more cations of formulae (I)—(VIII). An exemplary aspect of the cation is an alkyl imidazolium, which can be paired, for example, with a bromide anion.

In aspects, the ionic liquid may include an anion selected from the group consisting of hexafluorophosphate, bistriflimide (Tf₂N⁻ or (CF₃SO₂)₂N⁻), tetrafluoroborate, triflate, dicyanamide (N(CN)₂⁻), acetate, trifluoroacetate, nitrate, bromide, chloride, iodide, heptachlorodialuminate (Al₂Cl₇⁻), tetrachlorodialuminate (Al₂Cl₄⁻), a species of formula (IX), and mixtures thereof. The species of formula (IX) has the following structural formula:

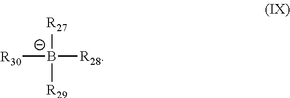

In examples of the ionic liquids of the present disclosure, R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, R₂₄, R₂₅, R₂₆, R₂₇, R₂₈, R₂₉, and R₃₀ may each independently be selected from the group consisting of hydrogen, (C₁-C₃₀)alkyl, (C₂-C₃₀)alkenyl, (C₂-C₃₀)alkynyl, aryl, heteroaryl, heterocyclyl, (C₁-C₃₀)alkoxy, (C₂-C₃₀)alkenyloxy, (C₂-C₃₀)alkynyloxy, aryloxy, heteroaryloxy, heterocyclyloxy, aryl(C₁-C₄)alkyl, heteroaryl(C₁-C₄)alkyl, heterocyclyl(C₁-C₄)alkyl, provided that all of R₁, R₂, R₃, and R₄ are not simultaneously hydrogen; provided that all of R₅, R₆, R₇, and R₈ are not simultaneously hydrogen; provided that all of R₉, R₁₀, and R₁₁ are not simultaneously hydrogen; provided that R₁₃ and R₁₄ are not simultaneously hydrogen; provided that R₁₈ and R₁₉ are not simultaneously hydrogen; provided that R₂₃ and R₂₄ are not simultaneously hydrogen; provided that R₂₅ and R₂₆ are not simultaneously hydrogen; provided that all of R₂₇, R₂₈, R₂₉, and R₃₀ are not simultaneously hydrogen; and optionally any two of R₁, R₂, R₃, and R₄, and/or any two of R₅, R₆, R₇, and R₈, and/or any two of R₉, R₁₀, and R₁₁, and/or any two adjacent substituent groups of R₁₃, R₁₄, R₁₅, R₁₆, and R₁₇, and/or any two adjacent substituent groups of R₁₈, R₁₉, R₂₀, R₂₁, and R₂₂, and/or R₂₃ and R₂₄ together, and/or R₂₅ and R₂₆ together, and/or any two of R₂₇, R₂₈, R₂₉, and R₃₀ each may, taken together, in either direction, be selected from the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclene, and (C₁-C₄)alkylheterocyclyl(C₁-C₄)alkylene.

“Alkyl,” by itself or as part of another substituent, means a straight, branched, or cyclic chain hydrocarbon (i.e., cycloalkyl) having the number of carbon atoms designated (i.e., “C₁-C₃₀” means one to thirty carbons). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl. Most preferred are —(C₁-C₁₈)alkyl. In aspects, a compound bearing a —(C₁-C₃₀)alkyl group may contribute to the surprising and unexpected effect of antimicrobial efficacy in an antimicrobial polymer composition without requiring a surface preparation. Accordingly, in such aspects, a —(C₁-C₃₀)alkyl group, whether straight, branched, or cyclic, may be selected from any one or more of —C₁ alkyl through —C₃₀ alkyl.

“Alkylene,” by itself or as part of another substituent, means a straight, branched, or cyclic chain bivalent saturated aliphatic radical having the number of carbon atoms designated such as methylene (i.e., C₁alkylene, or —CH₂—) or that may be derived from an alkene by opening of a double bond or from an alkane by the removal of two hydrogen atoms from different carbon atoms. Examples include methylene, methylmethylene, ethylene, propylene, ethylmethylene, dimethylmethylene, methylethylene, butylene, cyclopropylmethylene, dimethylethylene, and propylmethylene. In aspects, a compound bearing a —(C₁-C₃₀)alkylene group may contribute to the surprising and unexpected effect of antimicrobial efficacy in an antimicrobial polymer composition without requiring a surface preparation. Accordingly, in such aspects, a —(C₁-C₃₀)alkylene group, whether straight, branched, or cyclic, may be selected from one or more of —C₁ alkylene through —C₃₀ alkylene.

“Alkenyl,” by itself or as part of another substituent, means a stable mono-unsaturated or di-unsaturated straight chain, the unsaturation meaning a carbon-carbon double bond (—CH═CH—), branched chain or cyclic hydrocarbon group having the stated number of carbon atoms. Examples include vinyl, propenyl, allyl, crotyl, isopentenyl, butadienyl, 1,3-pentadienyl, 1,4-pentadienyl, cyclopentenyl, cyclopentadienyl, and the higher homologs and isomers. Functional groups representing an alkene are exemplified by —CH═CH—CH₂— and CH₂═CH—CH₂—. In aspects, a compound bearing a —(C₂-C₃₀)alkenyl group may contribute to the surprising and unexpected effect of antimicrobial efficacy in an antimicrobial polymer composition without requiring a surface preparation. Accordingly, in such aspects, a —(C₂-C₃₀)alkenyl group, whether straight, branched, or cyclic, may be selected from one or more of —C₂ alkenyl through a —C₃₀alkenyl.

“Alkenylene,” by itself or as part of another substituent, means a straight, branched, or cyclic chain bivalent unsaturated aliphatic radical containing a double bond having the number of carbon atoms designated and that may be derived from an alkyne by opening of a triple bond or from an alkene by the removal of two hydrogen atoms from different carbon atoms. In aspects, a compound bearing a —(C₂-C₃₀)alkenylene group may contribute to the surprising and unexpected effect of antimicrobial efficacy in an antimicrobial polymer composition without requiring a surface preparation. Accordingly, in such aspects, a —(C₂-C₃₀)alkenylene group, whether straight, branched, or cyclic, may be selected from one or more of —C₂ alkenylene through —C₃₀ alkenylene.

“Alkynyl,” by itself or as part of another substituent, means a stable carbon-carbon triple bond-containing radical (—C≡C—), branched chain, or cyclic hydrocarbon group having the stated number of carbon atoms (i.e., “C₂-C₃₀” means two to thirty carbons). Examples include ethynyl and propargyl. In aspects, a compound bearing a —(C₂-C₃₀)alkynyl group may contribute to the surprising and unexpected effect of antimicrobial efficacy in an antimicrobial polymer composition without requiring a surface preparation. Accordingly, in such aspects, a —(C₂-C₃₀)alkynyl group, whether straight, branched, or cyclic, may be selected from one or more of —C₂ alkynyl through —C₃₀ alkynyl.

“Alkynylene,” by itself or as part of another substituent, means a straight, branched, or cyclic chain bivalent unsaturated aliphatic radical containing a triple bond having the number of carbon atoms designated (i.e., “C₂-C₃₀” means two to thirty carbon atoms) and that may be derived from an alkyne by the removal of two hydrogen atoms from different carbon atoms. In aspects, a compound bearing a —(C₂-C₃₀)alkynylene group may contribute to the surprising and unexpected effect of antimicrobial efficacy in an antimicrobial polymer composition without requiring a surface preparation. Accordingly, in such aspects, a —(C₂-C₃₀)alkynylene group, whether straight, branched, or cyclic, may be selected from one or more of —C₂ alkynylene through —C₃₀ alkynylene.

“Alkoxy,” by itself or as part of another substituent, means an alkyl group having the designated number of carbon atoms, as defined above, connected to the rest of a molecule via an oxygen atom, such as, for example, methoxy, ethoxy, 1-propoxy, 2-propoxy (i.e., isopropoxy), and the higher homologs and isomers. In aspects, a compound bearing a —(C₁-C₃₀)alkoxy group may contribute to the surprising and unexpected effect of antimicrobial efficacy in an antimicrobial polymer composition without requiring a surface preparation. Accordingly, in such aspects, a —(C₁₋₃₀)alkoxy group, whether straight, branched, or cyclic, may be selected from one or more of —C₁ alkoxy through —C₃₀ alkoxy.

“Alkenyloxy,” by itself or as part of another substituent, means an alkenyl group having the designated number of carbon atoms, as defined above, connected to the rest of the molecule via an oxygen atom. “Alkynyloxy” means an alkynyl group having the designated number of carbon atoms, as defined above, connected to the rest of the molecule via an oxygen atom. “Aromatic” refers to a carbocycle or heterocycle having one or more polyunsaturated rings having aromatic character (i.e., having (4n+2) delocalized π (pi) electrons where n is an integer).

“Aryl,” by itself or in combination with another substituent, means a carbocyclic aromatic system containing one or more rings (typically one, two or three rings) wherein such rings may be attached together in a pendant manner, such as biphenyl, or may be fused, such as naphthalene. Examples may include phenyl, benzyl, anthracyl, and naphthyl. Preferred are phenyl, benzyl, and naphthyl; most preferred are phenyl and benzyl. “Aryloxy” means an aryl group connected to the rest of the molecule via an oxygen atom. “Arylene” means a bivalent radical produced by the removal of two hydrogen atoms from two different carbon atoms of an aryl group.

“Heterocycle” or “heterocyclyl” or “heterocyclic,” by themselves or as part of other substituents, mean an unsubstituted or substituted, stable, mono- or multi-cyclic heterocyclic ring system that consists of carbon atoms and at least one heteroatom independently selected from the group consisting of N, O, and S, and wherein the nitrogen and sulfur heteroatoms may be optionally oxidized, and the nitrogen atom may be optionally quaternized. The heterocyclic system may be attached, unless otherwise stated, at any heteroatom or carbon atom that affords a stable structure. “Heterocyclyloxy” means a heterocyclyl group connected to the rest of the molecule via an oxygen atom. “Heterocyclylene” means a bivalent radical produced by the removal of two hydrogen atoms from two different carbon atoms of a heterocyclyl group. “Heteroaryl” or “heteroaromatic” mean a heterocyclic having aromatic character. A polycyclic heteroaryl may include fused rings. Examples include indole, 1H-indazole, 1H-pyrrolo[2,3-b]pyridine, and the like. A polycyclic heteroaryl may include one or more rings that are partially saturated. Examples include indoline, tetrahydroquinoline, and 2,3-dihydrobenzofuryl. Non-limiting examples of heteroaryl groups include: pyridyl; pyrazinyl; pyrimidinyl, particularly 2- and 4-pyrimidinyl; pyridazinyl; thienyl; furyl; pyrrolyl, particularly 2-pyrrolyl; imidazolyl; thiazolyl; oxazolyl; pyrazolyl, particularly 3- and 5-pyrazolyl; isothiazolyl; 1,2,3-triazolyl; 1,2,4-triazolyl; 1,3,4-triazolyl; tetrazolyl; 1,2,3-thiadiazolyl; 1,2,3-oxadiazolyl; 1,3,4-thiadiazolyl; and 1,3,4-oxadiazolyl. Polycyclic heterocycles include both aromatic and non-aromatic polycyclic heterocycles. Non-limiting examples of polycyclic heterocycles include: indolyl, particularly 3-, 4-, 5-, 6-, and 7-indolyl; indolinyl; indazolyl, particularly 1H-indazol-5-yl; quinolyl; tetrahydroquinolyl; isoquinolyl, particularly 1- and 5-isoquinolyl; 1,2,3,4-tetrahydroisoquinolyl; cinnolyl; quinoxalinyl, particularly 2- and 5-quinoxalinyl; quinazolinyl; phthalazinyl; naphthyridinyl, particularly 1,5- and 1,8-naphthyridinyl; 1,4-benzodioxanyl; coumaryl; dihydrocoumaryl; benzofuryl, particularly 3-, 4-, 5-, 6-, and 7-benzofuryl; 2,3-dihydrobenzofuryl; 1,2-benzisoxazolyl; benzothienyl, particularly 3-, 4-, 5-, 6-, and 7-benzothienyl; benzoxazolyl; benzothiazolyl, particularly 2- and 5-benzothiazolyl; purinyl; benzimidazolyl, particularly 2-benzimidazolyl; benztriazolyl; thioxanthinyl; carbazolyl; carbolinyl; acridinyl; pyrrolizidinyl; pyrrolo[2,3-b]pyridinyl, particularly 1H-pyrrolo[2,3-b]pyridine-5-yl; and quinolizidinyl. Particularly preferred are 4-indolyl, 5-indolyl, 6-indolyl, 1H-indazol-5-yl, and 1H-pyrrolo[2,3-b]pyridine-5-yl. “Heteroaryloxy” means a heteroaryl group connected to the rest of the molecule via an oxygen atom. “Heteroarylene” means a bivalent radical produced by the removal of two hydrogen atoms from two different carbon atoms of a heteroaryl group.

The terms “aryl(C₁-C₄)alkyl” means a functional group wherein a one to four carbon alkylene chain is attached to an aryl group (e.g., —CH₂—CH₂-phenyl). Examples may include benzyl. The term “heteroaryl(C₁-C₄)alkyl” means a functional group wherein a one to four carbon alkylene chain is attached to a heteroaryl group (e.g., —CH₂—CH₂-pyridyl). The term “heterocyclyl(C₁-C₄)alkyl” means a functional group wherein a one to four carbon alkylene chain is attached to a heterocyclyl group (e.g., —CH₂—CH₂-aziridine). The terms “aryl(C₁-C₄)alkylene” or “(C₁-C₄)alkylarylene” means a bivalent radical produced by the removal of two hydrogen atoms from two different carbon atoms of an aryl(C₁-C₄)alkyl group, preferably wherein one of the two different carbon atoms is in the (C₁-C₄)alkyl group and the other of the two different carbon atoms is in the aryl group. The term “(C₁-C₄)alkylaryl(C₁-C₄)alkylene” means a bivalent radical produced by the removal of two hydrogen atoms from two different carbon atoms of a (C₁-C₄)alkylaryl(C₁₋₄)alkyl group, wherein one of the two different carbon atoms is in one of the (C₁-C₄)alkyl groups and the other of the two different carbon atoms is in the other of the (C₁-C₄)alkyl groups (e.g., —CH₂-phenyl-CH₂—). The terms “heteroaryl(C₁-C₄)alkylene” or “(C₁-C₄)alkylheteroarylene” mean a bivalent radical produced by the removal of two hydrogen atoms from two different carbon atoms of a heteroaryl(C₁-C₄)alkyl group, preferably wherein one of the two different carbon atoms is in the (C₁-C₄)alkyl group and the other of the two different carbon atoms is in the heteroaryl group. The term “(C₁-C₄)alkylheteroaryl(C₁-C₄)alkylene” means a bivalent radical produced by the removal of two hydrogen atoms from two different carbon atoms of a (C₁-C₄)alkylheteroaryl(C₁-C₄)alkyl group, wherein one of the two different carbon atoms is in one of the (C₁-C₄)alkyl groups and the other of the two different carbon atoms is in the other of the (C₁-C₄)alkyl groups (e.g., —CH₂-pyridinyl-CH₂—). The terms “heterocyclyl(C₁-C₄)alkylene” or “(C₁-C₄)alkylheterocyclene” means a bivalent radical produced by the removal of two hydrogen atoms from two different carbon atoms of a heterocyclyl(C₁-C₄)alkyl group, preferably wherein one of the two different carbon atoms is in the (C₁-C₄)alkyl group and the other of the two different carbon atoms is in the heterocyclyl group. The term “(C₁-C₄)alkylheterocyclyl(C₁-C₄)alkylene” means a bivalent radical produced by the removal of two hydrogen atoms from two different carbon atoms of a (C₁-C₄)alkylheterocyclyl(C₁-C₄)alkyl group, wherein one of the two different carbon atoms is in one of the (C₁-C₄)alkyl groups and the other of the two different carbon atoms is in the other of the (C₁-C₄)alkyl groups (e.g., —CH₂-aziridinyl-CH₂—).

In aspects, the ionic liquid can comprise, as a wt % of the antimicrobial polymer composition, from about 5 wt % to about 30 wt %, from about 8 wt % to about 25 wt %, from about 10 wt % to about 20 wt %, from about 12 wt % to about 15 wt %, or any range or subrange therebetween. In further aspects, the ionic liquid can leach copper ions from the copper-containing material that can be transported to a surface of the antimicrobial polymer composition. In aspects, an amount (wt %) of the ionic liquid can be substantially equal to an amount (wt %) of the copper-containing material. In aspects, an amount (wt %) of the ionic liquid can be greater than an amount (wt %) of the copper-containing material, for example, by 1 wt % or more, by 2 wt % or more, 5 wt % or more, or 10 wt % or more. In aspects, an amount (wt %) of the copper-containing material can be greater than an amount (wt %) of the ionic liquid, for example, by 1 wt % or more, by 2 wt % or more, 5 wt % or more, or 10 wt % or more.

The antimicrobial polymer composition comprises a thermoplastic polymer. As used herein, “thermoplastic” means a polymeric material that can be reformed after an initial curing (e.g., polymerization) reaction by heating the material. A thermoplastic polymer is to be contrasted with a thermoset polymer, which cannot be reformed after an initial curing reaction. In aspects, the thermoplastic polymer can include one or more of acrylic resins (e.g., polyacrylic acids or ester derivatives, polymethylmethacrylate (PMMA)), polyamides (e.g., Nylons, polyamide-6, polyamide-12, polyamide6.6, polyarylamides), thermoplastic polyurethanes (TPUs), polyolefins, styrenic resins (e.g., polystyrene (PS)), polycarbonate (PC), polyureas, polyimides (PIs) (e.g., polyetherimide (PEI)), polyesters (e.g., polybutylene terephthalate (PBT), polyethylene terephthalate (PET), polylactic acid (PLA)), fluoropolymers, chloroploymers (e.g., polyvinyl chloride (PVC)), silicone resins, polybenzimidazoles (PBI), polyoxymethylene (POM), polypropylene oxide, polyether ether ketone (PEEK), polyphenylenes (e.g., polyphenylene oxides (PPO), polyphenylene sulfides (PPS)), benzoxazines hybridized with epoxy and phenolic resins, vinyl ester resins, and blends or copolymers including terpolymers etc. thereof (e.g., poly(acrylonitrile-co-butadiene-co-styrene) (ABS), poly(ethylene-co-butylene), poly(ethylene-co-butylene-co-styrene), poly(ethylene-co-propylene), poly(styrene-co-ethylene-co-butylene-co-styrene) (SEBS), poly(styrene-butadiene-styrene) (SBS), poly(acrylonitrile-co-styrene) (SAN), high-impact polystyrene (HIPS)). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Exemplary aspects of polyolefins include polyethylenes (PE) (e.g., ultra-low-density polyethylene (ULDPE), very-low-density polyethylene (VLDPE), low-density polyethylene (LDPE), linear low-density polyethylene (LLPE), medium density polyethylene (MDPE) high density polyethylene (HDPE), ultra-high molecular-weight polyethylene (UHMiWPE)), polypropylene (PP), polymethylpentane (PMP), polybutylenes, polypentenes, polyhexenes, polyoctenes, and derivatives or blends or copolymers thereof. In aspects, the thermoplastic polymer can be a thermoplastic elastomer. Exemplary aspects of thermoplastic polymers include polyamides (e.g., polyamide 6), TPUs, PBT, and PS, more preferably, polyamides and TPUs.

In aspects, the thermoplastic polymer can comprise a balance of the thermoplastic polymer composition after accounting for the copper-containing material, the ionic liquid, and any additives. In aspects, the thermoplastic polymer can comprise, as a wt % of the antimicrobial polymer composition, from 60 wt % to about 90 wt %, from about 60 wt % to about 89 wt %, from about 60 wt % to about 88 wt %, from about 65 wt % to about 85 wt %, from about 65 wt % to about 83 wt %, from about 70 wt % to about 80 wt %, from about 72 wt % to about 79 wt %, from about 75 wt % to about 78 wt %, or any range or subrange therebetween.

In aspects, the antimicrobial polymer composition may optionally include one or more additives. In further aspects, additives may include impact modifiers, flame retardants, ultraviolet inhibitors, antistatic agents, mold release agents, fillers, and/or colorants. Examples of impact modifiers may include methacrylate butadiene styrene terpolymer, acrylate polymethacrylate copolymer, chlorinated polyethylene (CPE), ethylene-vinyl acetate copolymer (EVA), acrylonitrile butadiene styrene terpolymer, and the like. In aspects, the one or more additives can comprise, as a wt % of the antimicrobial polymer composition, from about 0.1 wt % to about 10 wt %, from about 0.5 wt % to about 8 wt %, from about 1 wt % to about 5 wt %, from about 2 wt % to about 3 wt %, or any range or subrange therebetween.

Examples of antimicrobial polymer compositions may include particular combinations of ionic liquid(s), copper-containing material, and thermoplastic(s) that ultimately provide the effect of antimicrobial efficacy without surface preparation. The antimicrobial polymer compositions of the examples of the present disclosure demonstrate antimicrobial efficacy without a surface preparation method and may be used directly for extrusion compounding and injection molding to make final products. Additionally, the antimicrobial polymer compositions of the examples of the present disclosure are easily processable, have high flow, and do not mechanically deteriorate. The use of an ionic liquid in antimicrobial polymer compositions of the examples of the present disclosure also increase the environmental friendliness of the antimicrobial polymer compositions.

Table 1 presents ranges R1-R8 that are exemplary aspects of the antimicrobial polymer compositions. As shown in Table 1, range R1 is the broadest range. Range R2 is free of additives while ranges R1 and R3-R8 can optionally comprise additives. Ranges R3-R6 cover different subranges of range R1, where the range for the copper-containing material is the same as the range for the ionic liquid. Range R7 comprises more ionic liquid than copper-containing material while range R8 comprises more copper-containing material than ionic liquid. It is to be understood that the ranges in Table 1 can be combined with one another or one or more of the corresponding ranges or subranges discussed above for the corresponding component of the antimicrobial polymer composition.

TABLE 1
Ranges for Antimicrobial Polymer Compositions

| Component | R1 | R2 | R3 | R4 | R5 | R6 | R7 | R8 |
|---|---|---|---|---|---|---|---|---|
| Copper- | 5-30 | 5-30 | 5-10 | 10-15 | 15-20 | 20-25 | 5-10 | 15-20 |
| containing | | | | | | | | |
| material | | | | | | | | |
| Ionic Liquid | 5-30 | 5-30 | 5-10 | 10-15 | 15-20 | 20-25 | 15-20 | 5-10 |
| Thermoplastic | 60-90 | 60-90 | 80-90 | 70-80 | 60-70 | 50-60 | 70-80 | 70-80 |
| Polymer | | | | | | | | |
| Additives | 0-10 | 0 | 0-10 | 0-10 | 0-10 | 0-10 | 0-10 | 0-10 |

In aspects, the antimicrobial polymer composition can comprise a form of a powder, a chip, a flake, or a pellet. As used herein, “powder” comprises an effective diameter of about 0.2 millimeters (mm) or less. Throughout the disclosure, “effective diameter” refers to the diameter of a hypothetical sphere having the same volume as the measured material, where the volume of the material is measured using microscopy. Powders can comprise a substantially spherical shape. As used herein, a “pellet” comprises an effective diameter from 0.5 mm to 5 mm. Pellets can comprise a cylindrical shape or a polygonal cross-section that is substantially uniform along a length of the pellet. As used herein, a “flake” comprises an aspect ratio of 4 or more. Throughout the disclosure, aspect ratio is the ratio of the maximum dimension (i.e., length) to the larger of the dimensions (e.g., width, thickness) perpendicular to the maximum dimension (i.e., length). Throughout the disclosure, “chips” comprise materials comprising an effective diameter less than 5 mm that are not otherwise categorized as a power, a flake, or a pellet. Alternatively, the antimicrobial polymer composition can be formed into a molded, extruded, or injection molded article exhibiting antimicrobial properties.

In aspects, the antimicrobial polymer composition can be configured to be used as a masterbatch composition. As used herein, a “masterbatch” composition is configured to be mixed with another material (e.g., thermoplastic polymer) to form a finished article. Consequently, the masterbatch contains higher amounts (e.g., concentrations, wt %) of one or more components (e.g. copper-containing material, ionic liquid) than the resulting article. Providing the antimicrobial polymer composition as a masterbatch can simplify processing to produce an antimicrobial polymer article, where the masterbatch can be mixed with another thermoplastic without concern for dispersion and/or incorporation of components in the masterbatch since these components are already incorporated and dispersed in the masterbatch. Likewise, in aspects, the antimicrobial polymer composition can be configured to be combined with another thermoplastic polymer to form an antimicrobial polymer article (discussed below).

The present disclosure provides an antimicrobial polymer article comprising the copper-containing material, the ionic liquid, and the thermoplastic polymer. As discussed throughout, the antimicrobial polymer article can be formed from an antimicrobial polymer composition.

In aspects, the copper-containing material of the antimicrobial polymer article can comprise any one or more of the materials discussed above for the copper-containing material with reference to the antimicrobial polymer composition. In further aspects, the copper-containing material can comprise cuprous oxide and/or glass-ceramic particles. In aspects, the copper-containing material can comprise, as a wt % of the antimicrobial polymer article, from about 0.1 wt % to about 30 wt %, from about 0.2 wt % to about 25 wt %, from about 0.3 wt % to about 20 wt %, from about 0.4 wt % to about 15 wt %, from about 0.5 wt % to about 10 wt %, from about 1 wt % to about 5 wt %, from about 2 wt % to about 3 wt %, or any range or subrange therebetween. In aspects, the copper-containing material can comprise, as a wt % of the antimicrobial polymer article, about 5 wt % or less, for example, from about 0.1 wt % to about 5 wt %, from about 0.3 wt % to about 3 wt %, from about 0.5 wt % to about 2 wt %, from about 0.7 wt % to about 1 wt %, or any range or subrange therebetween. As demonstrated in the Examples discussed below, antimicrobial properties (e.g., log reduction of 3 or more, log reduction of 4 or more, log reduction of 5 or more) can be exhibited for antimicrobial polymer articles comprising 5 wt % or less of the copper-containing material.

In aspects, the ionic liquid of the antimicrobial polymer article can comprise any one or more of the materials discussed above for the ionic liquid with reference to the antimicrobial polymer composition. In further aspects, the ionic liquid can be water soluble. An exemplary aspect of the cation is an alkyl imidazolium, which can be paired, for example, with a bromide anion. In aspects, the ionic liquid can comprise, as a wt % of the antimicrobial polymer article, from about 0.1 wt % to about 20 wt %, from about 0.2 wt %, to about 18 wt %, from about 0.3 wt % to about 15 wt %, from about 0.4 wt % to about 12 wt %, from about 0.5 wt % to about 10 wt %, from about 1 wt % to about 5 wt %, from about 2 wt % to about 3 wt %, or any range or subrange therebetween. In aspects, the ionic liquid can comprise, as a wt % of the antimicrobial polymer article, about 5 wt % or less, for example, from about 0.1 wt % to about 5 wt %, from about 0.3 wt % to about 3 wt %, from about 0.5 wt % to about 2 wt %, from about 0.7 wt % to about 1 wt %, or any range or subrange therebetween. In aspects, an amount (wt %) of the ionic liquid can be substantially equal to an amount (wt %) of the copper-containing material. In aspects, an amount (wt %) of the ionic liquid can be greater than an amount (wt %) of the copper-containing material, for example, by 0.1 wt % or more, by 0.5 wt % or more, 1 wt % or more, or 2 wt % or more. In aspects, an amount (wt %) of the copper-containing material can be greater than an amount (wt %) of the ionic liquid, for example, by 0.1 wt % or more, by 0.5 wt % or more, 1 wt % or more, or 2 wt % or more. As demonstrated in the Examples discussed below, antimicrobial properties (e.g., log reduction of 3 or more, log reduction of 4 or more, log reduction of 5 or more) can be exhibited for antimicrobial polymer articles comprising 5 wt % or less of the ionic liquid.

In aspects, the thermoplastic polymer of the antimicrobial polymer article can comprise any one or more of the thermoplastic polymers discussed above with reference to the antimicrobial polymer composition. For example, the thermoplastic material can be selected from a group consisting of a polyamide, a thermoplastic polyurethane, a polyolefin, a polyacrylate, a polyurea, a polyimide, polystyrene, polycarbonate, polyvinyl chloride, acrylonitrile butadiene styrene, a fluoropolymer, a polyester, a silicone resin, a terpolymer, and any combination or blend or copolymer thereof. Exemplary aspects of thermoplastic polymers include polyamides (e.g., polyamide 6), TPUs, PBT, and PS, more preferably, polyamides and TPUs. In aspects, the thermoplastic polymer can comprise a balance of the antimicrobial polymer article after accounting for the copper-containing material, the ionic liquid, and any additives. In aspects, the thermoplastic polymer can comprise, as a wt % of the antimicrobial polymer article, from 50 wt % to about 99.8 wt %, from about 55 wt % to about 99.7 wt %, from about 60 wt % to about 99.6 wt %, from about 65 wt % to about 99.5 wt %, from about 70 wt % to about 99 wt %, from about 75 wt % to about 98 wt %, from about 77 wt % to about 97 wt %, from about 80 wt % to about 96 wt %, from about 82 wt % to about 95 wt %, from about 85 wt % to about 94 wt %, from about 86 wt % to about 93 wt %, from about 87 wt % to about 92 wt %, from about 88 wt % to about 91 wt %, from about 89 wt % to about 90 wt %, or any range or subrange therebetween.

In aspects, the antimicrobial polymer article may optionally include one or more additives. In further aspects, additives may include impact modifiers, flame retardants, ultraviolet inhibitors, antistatic agents, mold release agents, fillers, and/or colorants. Examples of impact modifiers may include methacrylate butadiene styrene terpolymer, acrylate polymethacrylate copolymer, chlorinated polyethylene (CPE), ethylene vinyl acetate copolymer (EVA), acrylonitrile butadiene styrene terpolymer, and the like. In aspects, the one or more additives can comprise, as a wt % of the antimicrobial polymer article, from about 0.1 wt % to about 10 wt %, from about 0.5 wt % to about 8 wt %, from about 1 wt % to about 5 wt %, from about 2 wt % to about 3 wt %, or any range or subrange therebetween.

Examples of antimicrobial polymer articles may include particular combinations of ionic liquid(s), copper-containing material, and thermoplastic(s) that ultimately provide the effect of antimicrobial efficacy without surface preparation. The antimicrobial polymer articles of the present disclosure demonstrate antimicrobial efficacy without a surface treatment. Compositions of the antimicrobial polymer article are easily processable, have high flow, and do not mechanically deteriorate. The use of an ionic liquid in antimicrobial polymer article of the examples of the present disclosure also increase the environmental friendliness of the antimicrobial polymer compositions. In aspects, the antimicrobial polymer article can be configured to have a logarithmic reduction of at least 3, at least 4, or at least 5 for at least one of Staphylococcus aureus, Enterobacter aerogenes, Pseudomonas aeruginosa bacteria, Methicillin-Resistant Staphylococcus aureus, or E. coli.

Table 2 presents ranges R9-R14 that are exemplary aspects of the antimicrobial polymer articles. As shown in Table 2, range R9 is the broadest range while range R10 reduces the maximum amount of copper-containing material and the maximum amount of the ionic liquid. Range R11 is free of additives while ranges R9-R10 and R12-R14 can optionally comprise additives. Ranges R12-R14 cover different subranges of range R9 or R10. In ranges R9-R12, the range for the copper-containing material is the same as the range for the ionic liquid. Range R13 comprises more ionic liquid than copper-containing material while range R14 comprises more copper-containing material than ionic liquid. It is to be understood that the ranges in Table 2 can be combined with one another or one or more of the corresponding ranges or subranges discussed above for the corresponding component of the antimicrobial polymer article.

TABLE 2
Compositional Ranges for Antimicrobial Polymer Articles

| Component | R9 | R10 | R11 | R12 | R13 | R14 |
|---|---|---|---|---|---|---|
| Copper- | 0.1-30 | 0.1-5 | 0.1-5 | 0.5-5 | 0.5-3 | 3-5 |
| containing | | | | | | |
| material | | | | | | |
| Ionic Liquid | 0.1-20 | 0.1-5 | 0.1-5 | 0.5-5 | 3-5 | 0.5-3 |
| Thermoplastic | 50-99.8 | 80-99.8 | 90-99.8 | 85-99 | 82-96.5 | 82-96.5 |
| Polymer | | | | | | |
| Additives | 0-10 | 0-10 | 0 | 0-10 | 0-10 | 0-10 |

FIG. 1 schematically shows the antimicrobial polymer composition or the antimicrobial polymer article 100. As shown, the antimicrobial polymer composition or the antimicrobial polymer article 100 comprises a matrix 10 comprising the thermoplastic material and a plurality of particles 20 comprising the copper-containing material. As discussed above, the copper-containing material (e.g., particles 20) can be configured to provide a controlled release of copper ions. In aspects, the particles 20 can comprise cuprous oxide particles and/or copper-containing glass-ceramic particles. As shown, the plurality of particles 20 can be distributed throughout the matrix 10. Also, as shown, an exterior surface 40 of the antimicrobial polymer composition or the antimicrobial polymer article 100 includes an exposed portion of the matrix 10 and/or a particle of the plurality of particles 20. In aspect, other exterior surfaces 30 of the polymer article 100 can include exposed portions as well. Although not shown, the ionic liquid can allow the migration of copper ions from the copper-containing material (e.g., particles) to the exterior surface and/or the migration of moisture from the exterior surface to the copper-containing material (e.g., particles). Providing the ionic liquid can enhance an antimicrobial effect of the antimicrobial polymer composition and/or antimicrobial polymer article, for example, by allowing a relatively low amount of copper-maintaining material (e.g., about 5 wt % or less) to release copper ions that can effectively interact with microbial cells at the exterior surface. Although a planar surface is shown in FIG. 1, it is to be understood that the antimicrobial polymer composition or the antimicrobial polymer article can comprise any shape.

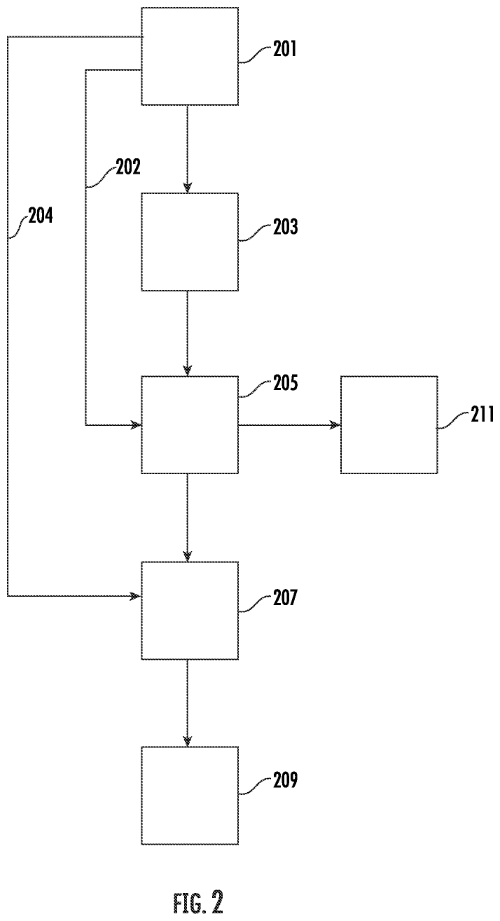

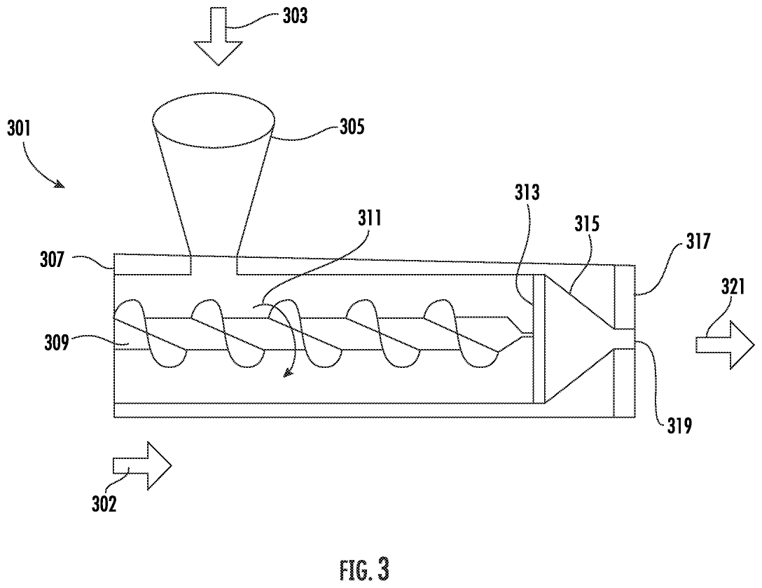

Aspects of methods of making the antimicrobial polymer composition and/or the antimicrobial polymer article in accordance with aspects of the disclosure will be discussed with reference to the flow chart in FIG. 2 and example method steps illustrated in FIG. 3.

Example aspects of making the antimicrobial polymer composition will now be discussed with reference to FIG. 3 and the flow chart in FIG. 2. In a first step 201, methods can start with obtaining an ionic liquid and a thermoplastic polymer. In aspects, the ionic liquid and/or the thermoplastic material can be obtained by purchase. In aspects, the thermoplastic polymer can comprise a powder, a chip, a flake, or a pellet; providing the thermoplastic material in one or more of these forms can improve a homogeneity of the resulting antimicrobial polymer composition and/or reduce processing resources (e.g., time, energy) to fully soften the thermoplastic material. In aspects, step 201 can comprise obtaining a copper-containing material.

After step 201, methods can proceed to step 203, comprising obtaining the copper-containing material. In aspects, the copper-containing material can be obtained by purchase. In aspects, the copper-containing material can be formed using a variety of glass-forming processes, for example, slot draw, down-draw, fusion down-draw, up-draw, press roll, redraw, or float. In further aspects, the copper-containing glass-ceramic particle can be provided by heating a glass-based material to crystallize one or more ceramic crystals. In even further aspects, a size (e.g., effective diameter, average maximum dimension) of the copper-containing glass-ceramic particle can be achieved by milling or grinding a copper-containing glass-ceramic material.

After step 201 or 203, as shown in FIG. 3, methods can proceed to step 205 comprising forming the antimicrobial polymer composition. In aspects, step 205 can comprise mixing the copper-containing material, the ionic liquid, and the thermoplastic polymer in an extruder 301 to form a mixture. In further aspects, the mixing can comprise blending the ionic liquid and the copper-containing material before adding it to the extruder 301. In even further aspects, the blended ionic liquid and the copper-containing material can be further blended with the thermoplastic material (e.g., pellets) to form the mixture that is fed into the extruder 301. As shown in FIG. 3 by arrow 303, the copper-containing material, the ionic liquid, and the thermoplastic polymer (e.g., individually or as a mixture) can be added to the hopper 305 of the extruder 301. The thermoplastic polymer (e.g., pellets) may be blended with the ionic liquid and the copper-containing material to prepare the mixture fed into the extruder, or the thermoplastic polymer may be separately fed into the extruder. The extruded antimicrobial polymer composition may be produced in the form of pellets for secondary downstream processing. Examples of downstream processing of pellets of an antimicrobial polymer composition prepared in an extruder may include injection molding, thermal forming, compression molding, transfer molding, casting, blow molding, calendaring, or laminating. In aspects, as shown in FIG. 3, the extruder can comprise one or more screws 309 (e.g., twin screws) rotating in direction 311 (e.g., twin screws can rotate in opposite directions) within a body 307 of the extruder 301. The mixture can be fed from the hopper 305 into the body 307 of the extruder 301, where the one or more screws 309 can soften the thermoplastic polymer, mix the mixture, and transport the mixture in direction 302. In aspects, the one or more screws 309 can be maintained at a temperature greater than a glass transition temperature (Tg) of the thermoplastic polymer or a melting temperature (Tm) if the thermoplastic polymer is crystalline. The glass transition temperature can be measured using dynamic mechanical analysis, where a maximum value of tan delta (ratio of the loss modulus to the elastic modulus) corresponds to the Tg. In aspects, as shown, the screw 309 can transport the mixture to a breaker plate 313 comprising a plurality of orifices that the mixture can be transported through to an adapter 315 comprising a die 317 with an orifice 319. The orifice 3191 of the die 317 can be selected to achieve a predetermined shape (e.g., pellets, powder, chips, flakes). As shown by arrow 321, the mixture can be extruded through the breaker plate 313 and the orifice 319 of the die 317 to produce the antimicrobial polymer composition.

After step 205, methods can be complete upon reaching step 211. As discussed throughout the disclosure, the antimicrobial polymer composition can be used in secondary (e.g., subsequent) downstream processing (e.g., in combination with another thermoplastic polymer) to form an antimicrobial article. For example, the antimicrobial polymer composition can be configured to be used as a masterbatch. In aspects, the antimicrobial polymer composition can comprise any one or more of the components and/or ranges discussed above for the corresponding component with reference to the antimicrobial polymer composition. In aspects, methods of making the antimicrobial polymer composition in accordance with aspects of the disclosure can proceed along steps 201, 203, 205, and 211 of the flow chart in FIG. 2 sequentially, as discussed above. In aspects, methods can follow arrow 202 from step 201 to step 205, for example, when the copper-containing material is already obtained at the end of step 201. Any of the above options may be combined to make an antimicrobial polymer composition in accordance with the aspects of the disclosure.

Example aspects of making the antimicrobial polymer article will now be discussed with reference to FIG. 3 and the flow chart in FIG. 2. Methods can start at step 201. Step 201 can comprise any one or more of the aspects discussed above for step 201 with reference to making the antimicrobial polymer composition.

After step 201, as indicated by arrow 204 and shown in FIG. 3, methods can proceed to step 207 comprising making an antimicrobial polymer article. In aspects, step 207 can comprise any one or more of the aspects discussed above for step 205. For example, step 207 can comprise (1) feeding an antimicrobial polymer composition and an another thermoplastic polymer into a forming apparatus; (2) softening the thermoplastic polymer and mixing it with the copper-containing material and the ionic liquid in the forming apparatus to form a mixed composition; and/or (3) forming the mixed composition into a predetermined shape (e.g., the antimicrobial polymer article).

In aspects, the predetermined shape can comprise a powder, a pellet, a flake, or a chip that can be further processed to produce the antimicrobial polymer article. For example, the further processing can comprise using one or more of extrusion, injection molding, compression molding, casting, blow molding, calendaring, and/or laminating. As used herein, “extrusion” refers to a standard technique known to those of ordinary skill in the art, in which a raw material is converted into a product of defined shape and density by forcing it through a die under defined conditions. For example, step 203, as discussed above with reference to FIG. 3, comprises extrusion. As used herein, “injection molding” refers to a manufacturing process for producing parts by injecting molten material into a mold. Injection molding generally includes feeding material for a part into a heated barrel, mixing the material using a helical screw, and injecting the heated material into a mold cavity, in which the material cools and hardens to the configuration of the cavity. As used herein, “thermal forming” refers to heating a thermoplastic sheet to its softening point, after which the sheet is stretched across a single-sided mold and manipulated, and finally cooled into a defined shape. As used herein, “compression molding” refers to preheating molding material, and placing the material in an open, heated mold cavity. Subsequently, the mold is closed with a top force or plug member, and pressure is applied to force the material into contact with mold areas, while heat and pressure are maintained until the molding material has cured. As used herein, “casting” refers to introducing molten material into a mold, allowing the molten material to solidify within the mold, and removing the solidified material from the mold once solidified. As used herein, “blow molding” refers to methods for forming and joining together hollow parts, for example, (1) extrusion blow molding, (2) injection blow molding, and (3) injection stretch blow molding. In extrusion blow molding (EBM), plastic is softened and extruded into a hollow tube, called a parison, which is then captured by closing the parison into a cooled metal solid. Air is blown into the parison, inflating it into a shape of a hollow bottle, container, or part. Once the plastic has cooled, the mold is opened and the solid is ejected. In injection blow molding (IBM), a polymer is injection molded onto a core pin, then the core pin is rotated to a blow molding station to be inflated and cooled, prior to ejection. In injection stretch blow molding (ISBM), plastic is molded into a “preform” by injection molding, which are packaged and fed later, after cooling, into a reheat stretch blow molding machine, in which the preforms are heated above their glass transition temperature, then blown using high-pressure air into bottles using metal blow molds. As used herein, “calendering” refers to smoothing and compressing a material during production by passing a single, continuous sheet through a number of pairs of heated rolls, which are called calenders. As used herein, “laminating” refers to combining two or more layers of material by either cohesion or adhesion.

After step 207, methods can be complete upon reaching step 209. As discussed throughout the disclosure, the antimicrobial polymer article can comprise any one or more of the components and/or ranges discussed above for the corresponding component with reference to the antimicrobial polymer article. In aspects, the thermoplastic polymer can be selected from a group consisting of a polyamide, a thermoplastic polyurethane, a polyolefin, a polyacrylate, a polyurea, a polyimide, polystyrene, polycarbonate, polyvinyl chloride, acrylonitrile butadiene styrene, a fluoropolymer, a polyester, a silicone resin, a terpolymer, and any combination or blend or copolymer thereof. Exemplary aspects of thermoplastic polymers include polyamides (e.g., polyamide 6), TPUs, PBT, and PS, more preferably, polyamides and TPUs. In aspects, the antimicrobial polymer article can comprise an additive selected from the group consisting of an impact modifier, a flame retardant, an ultraviolet inhibitor, an antistatic agent, a mold release agent, a filler, and a colorant. In aspects, the antimicrobial polymer article can comprise a logarithmic reduction of at least 3, at least 4, or at least 5 for at least one of Staphylococcus aureus, Enterobacter aerogenes, Pseudomonas aeruginosa bacteria, Methicillin-Resistant Staphylococcus aureus, or E. coli. In aspects, methods of making the antimicrobial polymer composition in accordance with aspects of the disclosure can proceed along steps 201, 207, and 209 of the flow chart in FIG. 2 sequentially, as discussed above. Any of the above options may be combined to make an antimicrobial polymer article in accordance with the aspects of the disclosure.

Example aspects of making the antimicrobial polymer article from an antimicrobial polymer composition will now be discussed with reference to FIG. 3 and the flow chart in FIG. 2. Methods can start at step 201. Step 201 can comprise obtaining another thermoplastic polymer and/or the antimicrobial polymer composition. In aspects, the antimicrobial polymer composition can be the product of step 205 or 211 and can comprise any one or more of the aspects of discussed above for the antimicrobial polymer composition. In aspects, the antimicrobial polymer composition can be obtained by purchase or by performing one or more of step 203, 205, and/or 207 discussed above. Alternatively, in aspects, after step 201, methods can proceed through steps 203 and/or 205 to produce the antimicrobial polymer article.

The thermoplastic polymer of the antimicrobial polymer composition can comprise a first functional group. The first functional group is a portion of the monomeric (i.e., repeat) structure. For example, polyvinyl chloride comprises a halogen functional group; a polyamide comprises an amide functional group; a polyacrylate comprises an acrylate functional group; a polyimide comprises an imide functional group; a polycarbonate comprises a carbonate functional group. In aspects, the another thermoplastic polymer can comprise the same first functional group as the thermoplastic polymer. Providing a common functional group in both the thermoplastic polymer and the another thermoplastic polymer can increase a compatibility of the thermoplastic polymers in the resulting antimicrobial polymer article, which can reduce processing costs, increase homogeneity of the resulting antimicrobial polymer article, and/or improve the antimicrobial effectiveness of the resulting antimicrobial polymer article. In aspects, the another thermoplastic polymer can comprise the same monomer as the thermoplastic polymer. As used herein, the “same monomer” means that at least one monomer (e.g., in a copolymer) in the thermoplastic polymer comprises the same chemical structure as a monomer (e.g., in a copolymer) in the another thermoplastic polymer even if the thermoplastic polymer and the another thermoplastic polymer are different polymers. In further aspects, a composition of the thermoplastic polymer can be the same as a composition of the another thermoplastic polymer. As used herein, two polymers have the same composition if all of the types of monomers in the first polymer also appear in the second copolymer and vice versa. In aspects, the another thermoplastic polymer and/or the thermoplastic polymer of the antimicrobial polymer composition can be selected from a group consisting of a polyamide, a thermoplastic polyurethane, a polyolefin, a polyacrylate, a polyurea, a polyimide, polystyrene, polycarbonate, polyvinyl chloride, acrylonitrile butadiene styrene, a fluoropolymer, a polyester, a silicone resin, a terpolymer, and any combination or blend or copolymer thereof. Exemplary aspects of another thermoplastic polymers include polyamides (e.g., polyamide 6), TPUs, PBT, and PS, more preferably, polyamides and TPUs.

In aspects, an amount (e.g., weight) of the another thermoplastic polymer can be greater than an amount (e.g., weight) of the thermoplastic polymer composition. In further aspects, a weight ratio of the another thermoplastic polymer to the antimicrobial composition can be about 5 or more, for example, from about 5 to about 30, from about 8 to about 25, from about 10 to about 20, from about 12 to about 15, or any range or subrange therebetween. For example, the antimicrobial thermoplastic polymer can be used as a masterbatch mixed with the another thermoplastic polymer to form a composition of the resulting antimicrobial polymer article. Providing the antimicrobial polymer composition can enable mixing with about 5 times or more of the another thermoplastic polymer while maintaining antimicrobial efficacy. In aspects, the antimicrobial polymer composition and/or the another thermoplastic polymer can comprise an additive selected from a group consisting of an impact modifier, a flame retardant, an ultraviolet inhibitor, an antistatic agent, a mold release agent, a filler, a colorant, and combinations thereof.

After step 201 or 205, as shown in FIG. 3, methods can proceed to step 207 comprising forming the antimicrobial polymer article. In aspects, step 207 can comprise feeding the antimicrobial polymer composition and the another thermoplastic polymer into a forming apparatus. In aspects, the antimicrobial polymer composition and/or the another thermoplastic polymer can comprise a powder, a pellet, a flake, or a chip. In aspects, the forming apparatus can be used for one or more of extrusion, injection molding, compression molding, casting, blow molding, calendaring, and/or laminating. For example, as indicated by arrow 303 in FIG. 3, the feeding can comprise disposing the antimicrobial polymer composition and the another thermoplastic polymer in the hopper 305. Step 207 can further comprise softening the antimicrobial polymer composition and the another thermoplastic polymer together in the forming apparatus to form a mixed composition. For example, with reference to FIG. 3, as the material in the hopper moves into the body 307 and/or is transported in the direction 302 by the screw, the material (e.g., the antimicrobial polymer composition and/or the another thermoplastic polymer) can be softened by the extruder 301 (e.g., maintained a temperature greater than the larger of a Tg of the thermoplastic polymer, a Tg of the another thermoplastic polymer, a Tm of the thermoplastic polymer (if crystalline), and a Tm of the another thermoplastic polymer (if crystalline)) and/or mixed by the screw 309 to form a mixed composition. Further, the mixed composition can be formed into a predetermined shape. For example, with reference to FIG. 3, the mixed composition within the body 307 of the extruder 301 can be extruded through the orifice 319 of the die 317 to form the predetermined shape. In aspects, the predetermined shape can correspond to the antimicrobial polymeric article. Alternatively, in aspects, the predetermined shape can be used in subsequent polymer processing (e.g., extrusion, injection molding, compression molding, casting, blow molding, calendaring, laminating) to form the antimicrobial polymer article.

After step 207, methods can be complete upon reaching step 209. The antimicrobial polymer article can comprise any one of the aspects (e.g., components and/or ranges) discussed above for the antimicrobial polymer article. In aspects, the antimicrobial polymer article can comprise a logarithmic reduction of at least 3, at least 4, or at least 5 for at least one of Staphylococcus aureus, Enterobacter aerogenes, Pseudomonas aeruginosa bacteria, Methicillin-Resistant Staphylococcus aureus, or E. coli. In aspects, methods of making the antimicrobial polymer article in accordance with aspects of the disclosure can proceed along steps 201, 203, 205, 207, and 209 of the flow chart in FIG. 2 sequentially, as discussed above, for example, if the antimicrobial polymer composition is not present at the end of step 201. In aspects, methods can follow arrow 202 from step 201 to step 205, for example, when the copper-containing material is already obtained at the end of step 201. Alternatively, in aspects, methods of making the antimicrobial polymer article in accordance with aspects of the disclosure can proceed along steps 201, 207, and 209 of the flow chart in FIG. 2 sequentially, as discussed above. This can correspond to following arrow 204 from step 201 to step 207, for example, if the antimicrobial polymer composition is present at the end of step 201. Any of the above options may be combined to make an antimicrobial polymer article in accordance with the aspects of the disclosure.

### Examples

The antimicrobial polymer compositions, antimicrobial polymer articles, and methods described above may be better understood in connection with the following Examples. In addition, the following non-limiting examples are an illustration. The illustrated methods are applicable to other examples of antimicrobial polymer compositions and/or antimicrobial polymer articles of the present disclosure. The procedures described as general methods describe what is believed will be typically effective to prepare the compositions indicated.

### Example Procedure for Preparation of an Antimicrobial Polymer Composition

Pellets of a thermoplastic polymer are fed into an extruder using a loss-in-weight feeder. An ionic liquid and a copper-containing material are mixed using a blender and then fed into the extruder using a second loss-in-weight feeder. The extruder barrel temperature is set at a temperature greater than a Tg of the thermoplastic polymer or a Tm of the thermoplastic polymer, if crystalline, (for example, thermoplastic polyurethane (TPU) a temperature of approximately 160° C. is used). The molten thermoplastic polymer is mixed with the copper-containing material and the ionic liquid in the extruder, and extruded into a desired shape (e.g., pellets for downstream secondary processing, a tube, a pipe, a sheet, or other shapes).

Alternatively, in another example, a thermoplastic polymer, an ionic liquid, and a copper-containing material are all mixed together using a blender, and fed into the extruder using one feeder.

### Procedure for Environmental Protection Agency (EPA) Microbial Testing

Stainless steel carriers, used as a reference, were cleaned and sterilized by immersion in a 75% ethanol solution followed by rinsing with deionized water. Vials containing Staphylococcus aureus (ATCC 6538) bacterial stock culture were stored at −80° C. until use. Aliquots of 20 μL of thawed bacterial cultures were added to 10 milliliters of Tryptic Soy Broth (Teknova). These bacterial suspensions were serially incubated three times at 36° C. for 18-24 hours in an orbital shaker (New Brunswick Scientific), and then one time in polypropylene snap tubes (Fisher Healthcare) for 48 hours. Cultures were subsequently mixed on a vortex mixer (VWR Scientific) and allowed to settle. The upper two-thirds of suspension from each tube was aspirated and OD₆₀₀ was measured (Smart Spec Spectrophotometer 3000, Bio-Rad) for bacterial density estimation. The culture was diluted with phosphate buffer saline (Gibco Life Technologies) to achieve a bacterial inoculum concentration near a target value of 1.0·0⁷ CFU/mL. Fetal bovine serum (0.25 mL of 5%, Gibco Life Technologies) and 0.05 mL Triton X-100 (Amresco Pro Pure) were added to 4.70 mL bacterial suspension to aid in spreading the inoculum. Each test sample was inoculated with 20 μL of the bacterial test culture. The inoculum volume was spread evenly using bent sterile pipette tips (Mettler-Toledo) to ensure full and even coverage. Samples were then incubated in a controlled environment set at 42% relative humidity and 23° C. for a period of 120 minutes. Following the 120-minute exposure period, samples were neutralized in Letheen broth (Gen Lab). Ten-fold serial dilutions of the neutralized solutions were plated using a standard spread plate technique on Tryptic Soy Agar plates and incubated for 24 hours at 36° C. to yield countable numbers of survivors (approximately 20-200 colonies per plate). Log and percentage of reductions for bactericidal efficacy tests measure differences in CFUs between stainless steel controls and antimicrobial polymer composition samples or antimicrobial polymer article samples. For an antimicrobial polymer composition or an antimicrobial polymer article to be considered a sanitizer, a ≥99.9% reduction (≥3 logarithmic reduction) must be demonstrated.

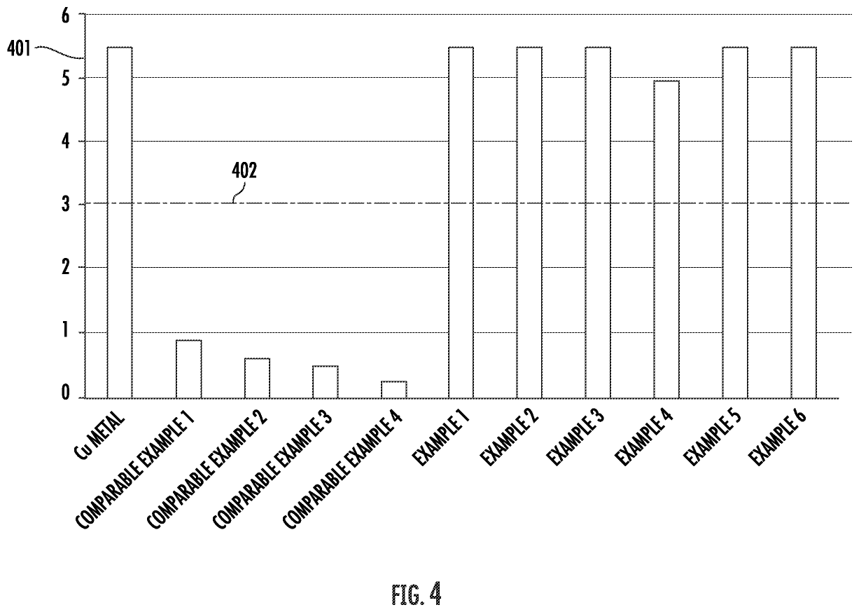

The amounts of each component from which the examples of antimicrobial polymer compositions were prepared are included in Table 3 below. For the Examples in Table 3 and FIGS. 4-6, polyamide 6 is Ultramid® B27 from BASF, TPU is Pearlthane 16n80 from Lubrizol, PBT is Ultradur 6650 from BASF, and PS is Styrolution 1600 from Ineos.

TABLE 3
Compositions of Thermoplastic Polymer, Copper-Containing Material, and
Ionic Liquid

| | | | Copper- | Weight | |
|---|---|---|---|---|---|
| Example | Thermoplastic | | Containing | Ratio | Logarithmic |
| No. | Polymer (A) | Ionic Liquid (B) | Material (C) | A:B:C | Reduction |
| Comparable | Polyamide 6 | — | Glass- | 95:0:5 | 0.87 |
| Example 1 | | | Ceramic | | |
| | | | Particles | | |
| Comparable | TPU | — | Glass- | 95:0:5 | 0.59 |
| Example 2 | | | Ceramic | | |
| | | | Particles | | |
| Comparable | TPU | 1-butyl-3- | Glass- | 90:5:5 | 0.45 |
| Example 3 | | methylimidazolium | Ceramic | | |
| | | hexafluorophosphate | Particles | | |
| Comparable | TPU | 1-butyl-3- | — | 90:5:0 | 0.19 |
| Example 4 | | methylimidazolium | | | |
| | | bromide | | | |
| Example 1 | Polyamide 6 | 1-butyl-3- | Glass- | 90:5:5 | 5.46 |
| | | methylimidazolium | Ceramic | | |
| | | bromide | Particles | | |
| Example 2 | TPU | 1-butyl-3- | Glass- | 90:5:5 | 5.72 |
| | | methylimidazolium | Ceramic | | |
| | | bromide | Particles | | |
| Example 3 | PBT | 1-butyl-3- | Glass- | 90:5:5 | 5.38 |
| | | methylimidazolium | Ceramic | | |
| | | bromide | Particles | | |
| Example 4 | PS | 1-butyl-3- | Glass- | 90:5:5 | 5.38 |
| | | methylimidazolium | Ceramic | | |
| | | bromide | Particles | | |
| Example 5 | Polyamide 6 | 1-butyl-3- | Cuprous | 93:5:2 | 5.72 |
| | | methylimidazolium | oxide | | |
| | | bromide | | | |
| Example 6 | TPU | 1-butyl-3- | Cuprous | 93:5:2 | 5.72 |
| | | methylimidazolium | oxide | | |
| | | bromide | | | |
| Cu Metal | — | — | Copper | — | 5.72 |
| | | | Metal | | |

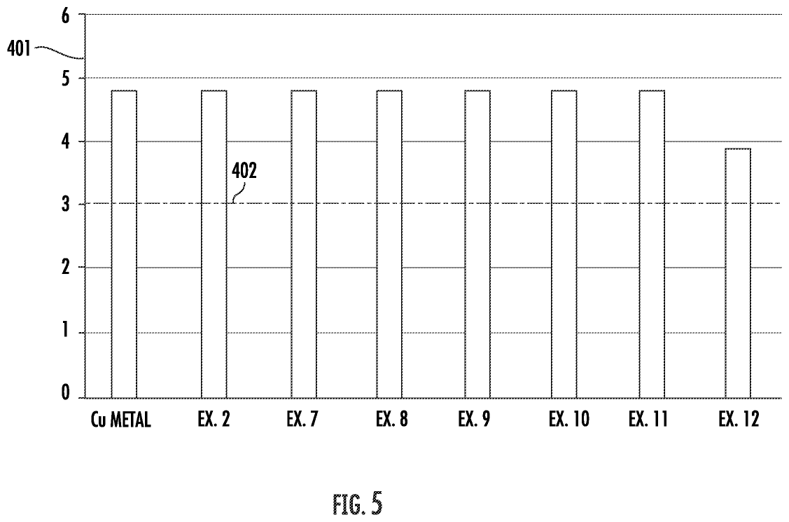

FIGS. 4-5 provide the results of antimicrobial testing of the examples of extruded antimicrobial polymer compositions prepared from a thermoplastic polymer(s), an ionic liquid, and a copper-containing material in the weight ratios indicated in Table 3. In FIGS. 4-5, the vertical axis 401 corresponds to a logarithmic reduction for antimicrobial testing. In FIGS. 4-5, dashed line 402 corresponds to a 3 logarithm reduction (i.e., the threshold to be a sanitizer). FIG. 4 and Table 3 present the results of antimicrobial testing for extruded samples of a combination of polyamide 6, TPU, PBT, or PS as the thermoplastic polymer. Comparable Examples 1-3 and Examples 1-4 comprised 5 wt % of the copper-containing glass-ceramic particles, Examples 5-6 comprised 2 wt % of cuprous oxide, and Comparable Example 4 did not comprise a copper-containing material. Comparable Example 4 and Examples 1-6 comprised 5 wt % of 1-butyl-3-methylimidazolium bromide (BMBr)(ionic liquid), Comparable Example 3 comprised 5 wt % of 1-butyl-3-methylimidazolium hexafluorophosphate (BMPF₆) (ionic liquid), and Comparable Examples 1-2 did not comprise an ionic liquid. Separately, each thermoplastic polymer was combined with the copper-containing glass-ceramic particles in 5 wt % absent the ionic liquid and the extruded samples were tested. FIG. 5 and Table 4 present the results of antimicrobial testing of separate extrudate samples of a combination of thermoplastic polyurethane (TPU) as the thermoplastic polymer and varying concentrations of both an ionic liquid and copper-containing glass-ceramic particles.

According to the results illustrated in FIGS. 4-5, 1-butyl-3-methylimidazolium bromide promotes antimicrobial efficacy for both TPU and polyamide 6 when each thermoplastic polymer is combined with even 0.5 wt % of copper-containing glass-ceramic particles. At such a level of the copper-containing material, it is expected that the mechanical properties of such examples of antimicrobial polymer compositions will not be appreciably impacted.

Comparing the results of antimicrobial testing of Comparable Example 3 and Example 2, as illustrated in FIG. 4, without being bound by theory, it is believed that the significant difference in antimicrobial efficacy between Comparable Example 3 and Example 2 is due to the 1-butyl-3-methylimidazolium bromide present as the ionic liquid in Example 2 as compared to the 1-butyl-3-methyl imidazolium hexafluorophosphate present as the ionic liquid in Comparable Example 3. Whereas the cation is the same for the ionic liquids in Comparable Example 3 and Example 2, the anions, which determine the water solubility of the ionic liquids, are different. Whereas 1-butyl-3-methylimidazolium bromide is water soluble, 1-butyl-3-methylimidazolium hexafluorophosphate is water insoluble. It is believed that the use of a water-soluble ionic liquid in an antimicrobial polymer composition increases the hydrophilicity of the antimicrobial polymer composition, such that the composition can absorb more water and help spread microbial-containing aqueous solution on the surface of the composition.

The 1-butyl-3-methylimidazolium cation contains a quaternary amine with a nitrogen bearing a positive formal charge, and thus it is believed that the 1-butyl-3-methylimidazolium species would exhibit antimicrobial efficacy by itself. Accordingly, a composition was prepared with 1-butyl-3-methylimidazolium bromide present and the copper-containing glass-ceramic particles absent (Comparable Example 4). The antimicrobial testing results illustrated that the composition demonstrated no antimicrobial efficacy. It is believed that the observed antimicrobial efficacy of Example 2 results from the combination of the copper-containing material with the water-soluble 1-butyl-3-methylimidazolium bromide.

As shown in FIG. 4 and Table 3, Examples 1-6 exhibit a logarithmic reduction greater than 3, greater than 4, and greater than 5. Further, Examples 2 and 5-6 comprised the same logarithmic reduction as copper (Cu) metal. This demonstrates that the ionic liquid (BMBr) in combination with a polyamide or TPU can achieve the same antimicrobial efficacy as 100 wt % copper with 5 wt % or less of copper-containing material.

As shown in FIG. 5, Examples 7-8 comprised 5 wt % copper-containing glass-ceramic particles, Examples 9-10 comprised 3 wt % copper-containing glass-ceramic particles, Example 11 comprised 1 wt % copper-containing glass-ceramic particles, and Example 12 comprised 0.5 wt % copper-containing glass-ceramic particles. Examples 7 and 9 comprised 3 wt % of the ionic liquid (BMBr), Examples 8 and 10-11 comprised 1 wt % of the ionic liquid (BMBr), and Example 12 comprised 0.5 wt % of the ionic liquid (BMBr). In Examples 7-8 and 10, there is more copper-containing material than ionic liquid.

As shown in FIG. 5 and Table 4, Examples 2 and 7-11 exhibit a logarithmic reduction greater than 3 and greater than 4 (i.e., 4.79). Examples 8 and 11 demonstrate that 1 wt % of the ionic liquid (e.g., BMBr) with 1 wt % or more of the copper-containing material can exhibit comparable (e.g., the same) antimicrobial efficacy as higher amounts of ionic liquid. Also, Example 12 demonstrates that even 0.5 wt % of copper-containing material in combination with an ionic liquid is sufficient to achieve a logarithmic reduction greater than 3 (i.e., 3.9).

TABLE 4
Compositions of TPU, BMBr, and
Copper-Containing Glass-ceramic

| | Weight | |
|---|---|---|
| Example | Ratio | Logarithmic |
| No. | A:B:C | Reduction |
| Cu Metal | — | 4.79 |
| Example 2 | 90:5:5 | 4.79 |
| Example 7 | 97:3:5 | 4.79 |
| Example 8 | 94:1:5 | 4.79 |
| Example 9 | 94:3:3 | 4.79 |
| Example 10 | 96:1:3 | 4.79 |
| Example 11 | 98:1:1 | 4.79 |
| Example 12 | 99:0.5:0.5 | 3.90 |

Table 5 presents the long-term antimicrobial efficacy of antimicrobial polymer compositions of Examples 1 and 2 including a thermoplastic polymer, copper-containing glass-ceramic particles, and 1-butyl-3-methylimidazolium bromide as an ionic liquid. As shown, Example 1 (with polyamide 6, a copper-containing material, and 1-butyl-3-methylimidazolium bromide) maintained its antimicrobial efficacy (logarithmic reduction greater than 4 and greater than 5) for all times tested (up to 1 year). Example 2 (with thermoplastic polyurethane, a copper-containing material, and 1-butyl-3-methylimidazolium bromide) maintained its antimicrobial efficacy (logarithmic reduction greater than 4 and greater than 5) for all times tested (up to 1 year). Both Examples 1-2 demonstrated full kill (equal to the copper control) for all times tested (up to 1 year).

TABLE 5
Logarithmic Reduction of Examples 1-2 over Time

| | Weight | | | | | |
|---|---|---|---|---|---|---|
| Example | Ratio | As- | 1 | 2 | 3 | 1 |
| No. | A:B:C | formed | month | months | months | year |
| Cu Metal | 0:0:100 | 5.46 | 5.46 | 5.46 | 5.46 | 5.46 |
| Example 1 | 95:0:5 | 5.46 | 5.46 | 5.46 | 5.46 | 5.46 |
| Example 2 | 95:0:5 | 5.46 | 5.46 | 5.46 | 5.46 | 5.46 |

The above observations can be combined to provide antimicrobial polymer compositions and/or antimicrobial polymer articles comprising a copper-containing material, an ionic liquid, and a thermoplastic polymer, and methods of making the same. The copper-containing material can enable the antimicrobial polymer composition and/or the antimicrobial polymer article to exhibit antimicrobial properties without surface treatment. The ionic liquid can increase an antimicrobial efficacy of the antimicrobial polymer composition, for example, by enabling copper ions to be transported between the copper-containing material and a location containing microbes (e.g., bacteria, viruses, fungi). Providing the ionic liquid can enhance an antimicrobial effect of the antimicrobial polymer composition and/or antimicrobial polymer article, for example, by allowing a relatively low amount of copper-maintaining material (e.g., about 5 wt % or less, about 2 wt % or less, about 0.5 wt %) to release copper ions that can effectively interact with microbial cells at the exterior surface. As demonstrated by the Examples, antimicrobial efficacy comparable to pure copper surfaces can be obtained with 5 wt % or less (e.g., 2 wt % or less) of the copper containing material. Further, the antimicrobial polymer article can satisfy the 3 logarithm reduction in antimicrobial activity to qualify as a sanitizer with about 0.5 wt % or less of the copper-containing material.

The antimicrobial polymer composition can be combined with another thermoplastic polymer using common polymer forming techniques to produce an antimicrobial polymer article. Providing the antimicrobial polymer composition as a masterbatch can simplify processing to produce an antimicrobial polymer article, where the masterbatch can be mixed with another thermoplastic without concern for dispersion and/or incorporation of components in the masterbatch since these components are already incorporated and dispersed in the masterbatch. Providing the antimicrobial polymer composition can enable mixing with about 5 times or more of the another thermoplastic polymer while maintaining antimicrobial efficacy. Providing a common functional group in both the thermoplastic polymer and the another thermoplastic polymer can increase a compatibility of the thermoplastic polymers in the resulting antimicrobial polymer article, which can reduce processing costs, increase homogeneity of the resulting antimicrobial polymer article, and/or improve the antimicrobial effectiveness of the resulting antimicrobial polymer article. Providing the antimicrobial polymer composition as a powder, a flake, a chip, or a pellet can improve a homogeneity of the resulting antimicrobial polymer composition and/or reduce processing resources (e.g., time, energy) to fully soften the thermoplastic material. Additionally, the antimicrobial polymer compositions of the examples of the present disclosure are easily processable, have high flow, and do not mechanically deteriorate. The use of an ionic liquid in antimicrobial polymer compositions of the examples of the present disclosure also increase the environmental friendliness of the antimicrobial polymer compositions.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint. Unless otherwise specified, “about,” when used in the context of a numerical value or range set forth means a variation of 15%, or less, of the numerical value.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

What is claimed is:

1. An antimicrobial polymer composition, comprising, based on a total 100 wt % of the antimicrobial polymer composition:
from about 5 wt % to about 30 wt % of a copper-containing material;
from about 5 wt % to about 30 wt % of an ionic liquid, the ionic liquid is water-soluble; and
from about 60 wt % to about 90 wt % of a thermoplastic polymer.

2. The antimicrobial polymer composition of claim 1, wherein the copper-containing material comprises cuprous oxide or a copper-containing glass-ceramic particle.

3. The antimicrobial polymer composition of claim 1, wherein the cation of the ionic liquid is an alkyl imidazolium.

4. The antimicrobial polymer composition of claim 1, wherein the antimicrobial polymer composition comprises a powder, a chip, a flake, or a pellet.

5. The antimicrobial polymer composition of claim 1, wherein the thermoplastic polymer comprises a thermoplastic polyurethane or a polyamide.

6. A method of making an antimicrobial polymer article comprising:
feeding an antimicrobial polymer composition and an another thermoplastic polymer into a forming apparatus;
softening the antimicrobial polymer composition and the another thermoplastic polymer together in the forming apparatus to form a mixed composition; and
forming the mixed composition into a predetermined shape,
wherein the antimicrobial polymer composition comprises, based on a total 100 wt % of the antimicrobial polymer composition:
from about 5 wt % to about 30 wt % of a copper-containing material;
from about 5 wt % to about 30 wt % of an ionic liquid, the ionic liquid is water-soluble; and
from about 60 wt % to about 90 wt % of a thermoplastic polymer.

7. The method of claim 6, wherein the mixed composition of the antimicrobial polymer article comprises, based on a total 100 wt % of the mixed composition:
from about 0.5 wt % to about 5 wt % of the copper-containing material; and
from about 0.5 wt % to about 5 wt % of the ionic liquid.

8. The method of claim 6, wherein a weight ratio of the another thermoplastic polymer to the antimicrobial polymer composition is from about 5 to about 30.

9. The method of claim 6, wherein the copper-containing material comprises cuprous oxide or a copper-containing glass-ceramic particle.

10. The method of claim 6, wherein the thermoplastic polymer comprises a first functional group, and the another thermoplastic polymer comprises the first functional group.

11. The method of claim 6, wherein a composition of the thermoplastic polymer is the same as a composition of the another thermoplastic polymer.

12. The method of claim 6, wherein the cation of the ionic liquid is an alkyl imidazolium.

13. The method of claim 6, wherein the antimicrobial polymer article comprises a logarithmic reduction of at least 3 for at least one of Staphylococcus aureus, Enterobacter aerogenes, Pseudomonas aeruginosa bacteria, Methicillin-Resistant Staphylococcus aureus, or E. coli.

14. The method of claim 6, wherein the forming apparatus comprises an extruder or an injection molding apparatus, and forming the mixed composition into the predetermined shape comprises extruding or injection molding the mixed composition.

15. The method of claim 6, further comprising, before the feeding the antimicrobial polymer composition and the another thermoplastic polymer:
mixing the copper-containing material, the ionic liquid, and the thermoplastic polymer in an extruder to form a mixture; and
extruding the mixture to form the antimicrobial polymer composition.

16. The method of claim 6, wherein the thermoplastic polymer comprises a thermoplastic polyurethane or a polyamide, and the another thermoplastic polymer comprises a thermoplastic polyurethane or a polyamide.

17. An antimicrobial polymer article comprising, based on a total 100 wt % of the antimicrobial polymer article:
from about 0.1 wt % to about 30 wt % of a copper-containing material;
from about 0.1 wt % to about 20 wt % of an ionic liquid, the ionic liquid is water-soluble; and
from about 50 wt % to about 99.8 wt % of a thermoplastic polymer.

18. The antimicrobial polymer article of claim 17, wherein the antimicrobial polymer article comprises:
from about 0.1 wt % to about 5 wt % of the copper-containing material; and
from about 0.1 wt % to about 5 wt % of the ionic liquid.

19. The antimicrobial polymer article of claim 17, wherein the copper-containing material comprises cuprous oxide or a copper-containing glass-ceramic particle.

20. The antimicrobial polymer article of claim 17, wherein the cation of the ionic liquid is an alkyl imidazolium; and/or wherein the antimicrobial polymer article is configured to have a logarithmic reduction of at least 3 for at least one of Staphylococcus aureus, Enterobacter aerogenes, Pseudomonas aeruginosa bacteria, Methicillin-Resistant Staphylococcus aureus, or E. coli.

21.-22. (canceled)
